(19) United States
(12) Patent Application Publication
(10) Pub. No.: US 2025/0172107 A1
(43) Pub. Date: May 29, 2025

(54) SLOW ACTUATION MECHANOLIQUID PISTON HEAT PUMP

(71) Applicant: VIANNEY RABHI, LYON (FR)

(72) Inventor: VIANNEY RABHI, LYON (FR)

(21) Appl. No.: 18/955,088

(22) Filed: Nov. 21, 2024

Related U.S. Application Data
(60) Provisional application No. 63/602,492, filed on Nov. 24, 2023.

(51) Int. Cl. F02G 1/053; F02G 1/055

(52) U.S. Cl. CPC F02G 1/0535; F02G 1/055; F02G 2244/50

(57) ABSTRACT

The slow-actuation mechanical liquid piston heat pump (1) with a blind liquid cylinder (8) in which a double-acting hydraulic piston (10) translates which is secured to a connecting rod (11) connected to connecting rod actuating means (144), a piston (10) forming with a cylinder (8) a compressor hydraulic variable volume (12) which communicates with a compressor gas and liquid reservoir (14) in which are housed heat exchange and accumulation means (16) to form a compressor (3), and a expander hydraulic variable volume (134) which communicates with a expander gas and liquid reservoir (137) in which are housed expander heat exchange and accumulation means (139) to form an expander (4).

The present invention relates to a slow-actuation mechanical liquid piston heat pump, which is reversible, and the main purpose of which is to air-condition and heat residential, tertiary, or industrial buildings.

In the scope of ecological transition, the heat pumps occupy an strategic place, as they can heat and air-condition buildings at a lesser energy cost, this by extracting renewable heat into the environment.

Building heating alone absorbs more than twenty percent of the world's primary energy, and this is why the market for low-temperature heat pumps, the most efficient, is destined to grow strongly in the coming years, but also that of high-temperature heat pumps, better suited to the renovation of old buildings, which remain the majority.

With global warming worsening and lifestyles changing, building air-conditioning already consumes more than ten percent of the electricity produced worldwide.

This share is intended to increase significantly both in proportion and volume, to the point that the efficiency of reversible heat pumps represents a major energy and economic challenge.

The principle of heat pumps currently used throughout the world is mainly based on state change, from vapour to liquid or vice versa, of a refrigerant fluid, the saturating vapour pressure of which is adapted to the targeted heating or refrigeration temperature range, and to the pressures that the installations can support.

State, or phase change refrigerating cycles have the advantage of a great calorie or refrigerant power density, as they utilise the latent heat from evaporation or from condensation of a refrigerant fluid by modulating the pressure and the temperature of said fluid, such that it evaporates or condenses at the right time.

In the current art, and considering economic, technological, physical limitations, and limitations in producing heat pumps, the state change refrigerating cycles remain by far the most efficient.

However, all refrigerating cycles do not resort to the state change of a specially formulated refrigerant fluid.

For example, the Brayton-Joule cycle, also called Bell-Coleman cycle, relies on the compression and the isentropic expansion of a gas without state change, with, after said compression, transfer of heat by said gas to a constant pressure colder environment and with, after said expansion, heat puncture by said gas to said enclosure to be cooled, also at a constant pressure.

However, the practical efficiency of the Bell-Coleman cycle remains low, with, in practice, a performance coefficient just greater than one and same often less than one, contrary to state change and refrigerant fluid heat pumps, the performance coefficient of which can culminate in four, even five for one, which means that for an invested energy unit, up to four to five energy units are collected in calorie or refrigerant form.

Due to its low practical energy efficiency, the Bell-Coleman cycle, is only mainly used when compressed air is naturally available, which can be the case in aeroplanes, and onboard certain trains.

Contrary to Bell-Coleman cycle heat pumps, due to their high efficiency, refrigerant fluid and state change heat pumps are widely used to heat or air condition buildings.

However, the efficiency of refrigerant fluid heat pumps remains a lot below the ideal Carnot efficiency which, by taking the temperature differences usually retained to take measurements, would give a performance coefficient greater than twenty, while the best heat pumps currently on the market deliver a performance coefficient of five.

But the ideal Carnot efficiency is only an indicator of the maximum efficiency theoretically accessible, as it does not consider the necessary temperature differences, such that the heat exchanges occur, nor the mechanical and practical stresses for producing heat pumps.

Clearly, there would be a significant advantage, due to the rarefaction of energy and of the climate and ecological challenges linked to said energy, to maximise the effectiveness coefficient of heat pumps used to produce heating, air-conditioning, or refrigerating as close as possible to the ideal Carnot efficiency.

Subject to having a compression and expansion machine with high energy efficiency, it would indeed be possible to approach the efficiency of the ideal Carnot cycle by using a fluid remaining entirely in the gaseous state, that is to say without change of state.

To achieve this aim, the compressor of said machine must compress a gas in two successive steps.

The first step consists of an adiabatic compression which occurs until the temperature of said gas is sufficiently high, such that the latter can transfer heat, for example, to a heating circuit of buildings, while the second step is an isothermal compression during which the temperature reached by said gas at the end of adiabatic compression is preserved during the rest of the compression of said gas, by gradually transferring to said heating circuit, the heat produced by said isothermal compression and this, until discharge of said gas outside of said compressor.

Then, the expander of said machine must expand the gas which has been compressed beforehand according to the process opposite that which has just been described, also in two successive steps.

The first step consists of an adiabatic expansion which occurs until the temperature of said gas is sufficiently low, such that the latter can extract heat, for example, in the environment outside of said building, while the second step is an isothermal expansion, during which the temperature reached by said gas at the end of adiabatic expansion is preserved during the rest of the expansion of said gas, by gradually extracting into said environment, the heat necessary for maintaining said temperature during the rest of said isothermal expansion, and this, until the discharge of said gas outside of said expander.

One of the advantages of such a heat pump is no longer resorting to polluting, toxic or combustible refrigerant fluids, which for some, destroy the ozone layer or produce a powerful greenhouse effect.

No longer depending on refrigerant fluids has an importance which is greater than European regulations, but also those of many countries, providing to prohibit, from 2030, refrigerant fluids, the global warming power of which is greater than or equal to one hundred and fifty times that of carbon dioxide.

These regulatory provisions will reduce the number of refrigerant fluids which can be used in conventional heat pumps, and will significantly impact the technology of said pumps, even increase the cost price of said pumps.

The most probable substitute for the refrigerant fluids currently used in conventional heat pumps is carbon dioxide, which is a non-polluting gas, the specific global warming power of which is low, but which has the main disadvantage of high operational pressures of more than one hundred atmospheres, which makes the sealing and the safety of installations more difficult to guarantee.

Other fluids under consideration are propane, which remains a flammable gas, or ammonia, which is corrosive and toxic.

It is therefore understood all the interest of reproducing as faithfully as possible, the heat pump ideal cycle of Sadi Carnot, by producing a quasi-isothermal compressor and volume expander, which use a fluid which remains in the gaseous state during the whole of said cycle.

This route is only possible by imposing a stable setpoint temperature on the gas during its compression or its isothermal expansion, which can be achieved with a medium which stores heat directly in a compression or expansion chamber, said medium being associated with means which export said heat during the compression phase, or which import said heat in the expansion phase.

Several designs rely on close-to-isothermal single-phase compressors or expanders with means for storing and importing or exporting heat.

This is the case, for example, of the quasi-isothermal machine that patent GB2534244 describes, said machine comprising a piston which is oriented downwards and which has a heat absorption and return structure, said piston compressing a gas in a variable volume in the bottom of which a constant fluid volume resides.

According to the invention of patent GB2534244, said piston compresses or expands said gas, while forcing the latter to cool or to heat in contact with the heat absorption and return structure, said structure being able to be constituted of metal sheets which, when they are outside of the liquid, exchange heat with the gas, while when they are immersed in said liquid, they exchange heat with the latter.

According to the invention of patent GB2534244, the liquid remains approximately immobile, contrary to liquid piston compressors, according to which the liquid is mobile on the contrary, which implies that said liquid is not subjected to decelerations which are too greater to that of the Earth's gravity, without causing the cavitation and the fluctuation of said liquid.

On the contrary, the invention of patent GB2534244 thus makes it possible to manufacture a rapid rotation compressor or expander without causing the liquid to move, which has the advantage of giving said compressor or said expander a high volume power density.

It is noted that the particular configuration of patent GB2534244 proposes a relatively conventional rod and crank system to actuate the piston carrying the heat absorption and return structure.

Another approach consists of moving a liquid by way of a piston which translates into a cylinder as patent CN111734604 provides, said liquid, contrary to patent GB2534244, submerging a static heat dissipator.

In the manner of patent CN111734605, numerous publications also state liquid pistons which alternatively force a gas and a liquid to pass through a porous medium or a heat accumulation and return system.

This technical approach is, in particular, retained by various research programmes dedicated to energy storage systems in the form of compressed air, for example, intended to accumulate renewable energy produced by offshore wind turbines.

It results from most of these devices that the compression or expansion efficiency highly depends on the total heat exchange surface between the gas, the liquid and the heat absorption and return structures, whatever the nature, but also on the time left for said exchanges to occur.

To favour said exchanges, it is therefore preferable to produce slow-rotation compressors or expanders, this in return for a lesser volume power.

Further to the time left for the heat exchanges to occur, the advantage of slow-rotation compressors or expanders is that they leave time for the transfer of gases to occur, so as to limit the pressure losses at the inlet and outlet ports of said compressors and expanders.

Indeed, if the latter rotate slowly, their actual thermodynamic pressure-volume diagram will be close to the ideal theoretical diagram, as less deformed by the transfer of gases, and the practical efficiency of a heat pump integrating said compressors and expanders will be closer to the maximum theoretical efficiency accessible according to the ideal Carnot cycle.

As, indeed, the inertia forces which reduce the performance of the controlled flaps and valves, responsible for transferring the gases in or outside of a compressor or an expander evolve more or less with the square of the rotation speed of said compressor or of said expander.

This results in a delay in opening and/or closing said flaps and valves which affects the effectiveness of the thermodynamic cycle.

Consequently from the above, a slow-rotation single-phase heat pump which compresses and expands a gas according to the Carnot cycle will initially occupy more volume than its conventional equivalent, the refrigerant fluid of which passes successively from the gaseous state to the liquid state and vice versa, and the compressor of which operates at a high speed.

The problem of slow-rotation compressors and expanders is that, at the same power, the mechanical parts which constitute them are subjected to greater forces than those which constitute their quicker equivalent, and that the large dimensions of said parts which result from said forces generate high energy losses by friction.

Further to a large dimension of said parts, the disadvantage of the slow-rotation of said compressors or expanders, is that it is unfavourable to establishing a hydrodynamic lubrication system between said parts, that this is, for example, at the friction interface of a piston in a cylinder, or at the pivot connections between said piston and a rod, between said rod and the crank of a crankshaft, and between the latter and a casing.

It would therefore be highly advantageous to implement liquid pistons coupled with heat exchange, storage, return, import and export means, by means of very high mechanical efficiency slow machines which leave a sufficiently long time, on the one hand, for heat exchanges to maximise their effectiveness, and on the other hand, for the transferring of gases to minimise their energy losses.

Such a configuration would make it possible to produce high energy performance heat pumps, delivering an efficiency closer to that of the ideal Carnot cycle, that their conventional counterparts which operate a state change refrigerant fluid, and only requiring, for example, atmospheric air and water to operate.

It would, for example, be possible to obtain from said configuration a performance coefficient of around seven, where under the same measuring conditions and in the same environment, the performance coefficient of the best refrigerant fluid heat pump on the market would be around five.

But, as has been described above, to obtain such an efficiency difference, it is necessary to produce a quasi-isothermal compression and expansion, by favouring, to the maximum, heat exchanges during said compression and said expansion, to limit, to the maximum, losses by transfer, losses by internal or external gas leakages, and to limit, to the maximum, losses by friction.

For example, the performance coefficient of a Carnot cycle single-phase heat pump, given its necessity to compress a greater quantity of gas than its state change refrigerant fluid counterpart, is necessarily very sensitive to the energy efficiency of its mechanical transmission device, said efficiency, if it is insufficient, having the consequence of giving said Carnot cycle single-phase heat pump a lower efficiency than that of its said counterpart.

Indeed, as a Carnot cycle single-phase heat pump must compress a greater quantity of gas than its state change refrigerant fluid counterpart, the performance coefficient of said single-phase heat pump is very dependent on the energy efficiency of its gas compression and expansion mechanical transmission device.

If said efficiency is insufficient, said single-phase heat pump will have a performance coefficient lower than that of its refrigerant fluid counterpart.

This sensitivity to the compression and expansion mechanical efficiency of a Carnot cycle single-phase heat pump is all the greater, when a performance coefficient greater than five is targeted, for example.

For example, a Carnot cycle single-phase heat pump which delivers ten kilowatts of thermal power with a performance coefficient of five, requires an external energy input of a power of two kilowatts in the form of mechanical work.

If the mechanical efficiency of said single-phase heat pump is mediocre and forms a mechanical loss of one kilowatt, the performance coefficient of said pump falls from five to three point three, and the energy bill of the owner of said pump increases by fifty percent.

In this case, said single-phase heat pump loses all its interest or almost all, with respect to its state change refrigerant fluid conventional equivalent.

This is why the slow-actuation mechanical liquid piston heat pump according to the invention provides an innovative configuration with a very high mechanical and volume efficiency, coupled with effective heat exchanges and flows, so as to give, in particular to Carnot cycle single-phase heat pumps which result from this, a performance coefficient significantly greater than that of their state change refrigerant fluid conventional equivalent.

Thus, the slow-actuation mechanical liquid piston heat pump according to the invention is mainly designed to produce heat pumps with a high coefficient of performance.

A heat pump results in particular, from the slow-actuation mechanical liquid piston heat pump according to the invention:
Which delivers a performance coefficient greater than that of conventional state change refrigerant fluid heat pumps, said pump according to the invention therefore reducing, other things being equal, the energy necessary to produce heat or cold;
The thermodynamic efficiency of which is close to that of the ideal Carnot cycle which by definition cannot be exceeded, to the point that, in all likelihood, the replacement of said heat pump with another design can barely be motivated by an additional improvement of the efficiency;
Which does not resort to any refrigerant fluid which is flammable, corrosive or damaging to health or to the environment, said pump being able to operate, for example, with atmospheric air or nitrogen and avoid any regulatory or safety limitation relating to handling, storage or recycling refrigerant fluids;
The operating temperature range of which is very expansive due to the non-dependency of said pump on any refrigerant fluid at all, said pump being able to operate in heating or air-conditioning mode, in any region in the world without damaging its efficiency;
Of a simple design, to the point that said pump can be produced in practically all countries in the world, in workshops at a technically modest level, in particular, by assembling low cost price components, which can be easily produced, or which are widely available on the market;
The simple mechanical configuration of which makes it possible to ensure its maintenance without great technical skill, and at a lesser cost;
Which makes it possible for any qualified plumber/heating engineer to simply, and in an accessible manner, produce a heating and air conditioning network which is easily integrated in buildings and in the environment of said buildings, this without requiring approval or certification linked to handling gases which are dangerous for health and the environment;
The robust mechanism of which, gives it a service life which can reach, subject to replacing minor parts, several decades without deterioration neither of the operation, nor of the efficiency of said pump, such a service life constituting an additional advantage of said pump for the environment, compared with conventional refrigerant fluid heat pumps when the entirety of the service life of said pumps is analysed, including manufacture and recycling;
Which is silent and which can be integrated in buildings by producing minimum noise pollution;
The arrangement of which makes it possible to expose, at a lesser cost, large heat exchange surfaces with the environment, by resorting to low rotation speed, low energy consumption, and low sound emission motor fans;
The manufacture of which does not require, neither rare or strategic material, nor highly technological knowhow and knowledge;

It is understood that the slow-actuation mechanical liquid piston heat pump according to the invention is intended, in addition to heat pumps, for any other application which is similar in concept and in principle and which could advantageously take advantage of the particular characteristics and functionalities of said mechanical liquid piston heat pump according to the invention.

The other features of the present invention have been described in the description and in the secondary claims depending directly or indirectly on the main claim.

The slow-actuation mechanical liquid piston heat pump, which comprises a compressor in which a compressor pneumatic variable volume is formed, and an expander in which a expander pneumatic variable volume is formed, each said volume comprising, on the one hand, an inlet port through which a working gas can enter and, on the other hand, an outlet port through which said gas can exit, comprises:
At least one blind liquid cylinder which is formed by one or more coaxial cylindrical sections, which is directly or indirectly secured to a static frame, at least two ends of which are each closed off by a sealed cylinder termination, and in which at least one double-acting hydraulic piston comprising one or more coaxial sealed discs can translate in a sealed manner, said piston having, on the one hand, at least one compressor side axial piston face which forms, with said cylinder and a sealed cylinder termination, a compressor hydraulic variable volume, and, on the other hand, at least one expander side axial piston face which forms, with said cylinder and another sealed cylinder termination, a expander hydraulic variable volume, the two said hydraulic variable volumes being completely or partially filled with a working liquid;
A compressor gas and liquid reservoir which is connected to the compressor hydraulic variable volume by a communication duct, such that said reservoir is mainly or totally filled with working liquid, when the hydraulic variable volume is minimum, and is partially or totally filled with working gas, when the hydraulic variable volume is maximum, the variation of volume of the working gas contained in the compressor gas and liquid reservoir forming, on the one hand, the compressor pneumatic variable volume, and being on the other hand, approximately equal to the variation of volume of the working liquid contained in the compressor hydraulic variable volume;
A expander gas and liquid reservoir which is connected to the expander hydraulic variable volume by a communication duct, such that said reservoir is mainly or totally filled with working liquid, when the expander hydraulic variable volume is minimum, and is partially or totally filled with working gas, when the expander hydraulic variable volume is maximum, the variation of volume of the working gas contained in the expander gas and liquid reservoir forming, on the one hand, the expander pneumatic variable volume, and being on the other hand, approximately equal to the variation of volume of the working liquid contained in the expander hydraulic variable volume;
Compressor heat exchange and accumulation means which are housed in the compressor gas and liquid reservoir, said means being able mainly to take heat from the working gas contained in said reservoir and temporarily store said heat, before yielding the latter to the working liquid also contained in said reservoir;
Expander heat exchange and accumulation means which are housed in the expander gas and liquid reservoir, said means being able mainly to take heat from the working liquid contained in said reservoir and temporarily store said heat, before yielding the latter to the working gas also contained in said reservoir;
Heat export means housed inside and/or outside the compressor gas and liquid reservoir, said means directly or indirectly taking heat from the compressor heat exchange and accumulation means, on the one hand, and/or from the working liquid and/or working gas contained in whole or in part in said reservoir, on the other hand, said heat then being transferred to heating means external to the compressor gas and liquid reservoir;
Heat import means housed inside and/or outside the expander gas and liquid reservoir, said means directly or indirectly supplying heat to the expander heat exchange and accumulation means, on the one hand, and/or to the working liquid and/or to the working gas that said reservoir contains in whole or in part, on the other hand, said heat having been previously taken from cooling means external to the expander gas and liquid tank;
Compressor filling means which enable or prohibit the passage of working gas from a compressor intake plenum to the compressor gas and liquid reservoir via the inlet port;
Compressor draining means which enable or prohibit the passage of working gas from the compressor gas and liquid reservoir to a compressor discharge plenum via the compressor outlet port;
Expander filling means which enable or prohibit the passage of working gas from an expander intake plenum to the expander gas and liquid reservoir via the expander inlet port;
Expander draining means which enable or prohibit the passage of working gas from the expander gas and liquid reservoir to an expander discharge plenum via the expander outlet port;
A connecting rod which is secured to the double-acting hydraulic piston, which sealingly passes through at least one of the ends of the blind liquid cylinder, and which is approximately parallel to the longitudinal axis of said piston and of the blind liquid cylinder;
Piston guiding means which maintain the hydraulic piston and the connecting rod parallel to said blind liquid cylinder, whatever the position of said piston in said cylinder;
Connecting rod actuating means by means of which a drive motor imparts to the connecting rod a reciprocating movement of longitudinal translation parallel to the axis of the blind liquid cylinder;
Mechanical energy storage means which are directly or indirectly connected to the connecting rod actuating means and/or to the connecting rod itself, said storage means being able alternatively to take and give mechanical energy to said actuating means and/or to said rod.

The slow-actuation mechanical liquid piston heat pump according to the invention comprises connecting rod actuating means which consist of a crankshaft which is oriented perpendicularly to the blind liquid cylinder, and which can rotate in at least one shaft bearing which is directly or indirectly secured to the static frame, said crankshaft having at least one crank about which a rod head of an actuating rod is articulated, the latter also comprising a rod foot which is articulated with the connecting rod, the latter passing in a sealed manner through at least one of the sealed cylinder terminations.

The slow-actuation mechanical liquid piston heat pump according to the invention comprises a rod foot which articulates with the connecting rod by means of a connecting crosshead which is secured to said connecting rod.

The slow-actuation mechanical liquid piston heat pump according to the invention comprises a connecting crosshead which comprises a crosshead yoke which is traversed by a crosshead axis which is perpendicular to the connecting rod and about which are articulated, on the one hand, a rod foot bearing which comprises the rod foot, and at least one crosshead roller which rolls on at least one crosshead raceway which is parallel to the blind liquid cylinder, and which is directly or indirectly secured to said cylinder.

The slow-actuation mechanical liquid piston heat pump of the invention comprises a double-acting hydraulic piston that consists of two coaxial sealed discs that are axially sufficiently distant from each other to leave a portion of the blind liquid cylinder not swept by said piston.

The slow-actuation mechanical liquid piston heat pump according to the invention comprises compressor heat exchange and accumulation means which are constituted of a porous medium which has porosities, into which and from which the working liquid and the working gas alternatively enter and exit.

The slow-actuation mechanical liquid piston heat pump according to the invention comprises heat export means which are constituted of a circulating part of the working liquid which leaves the compressor hydraulic variable volume and/or the compressor gas and liquid reservoir via a liquid outlet duct and then returns to said volume and/or to said reservoir via a liquid inlet duct, this after having directly or indirectly given heat to the heating means.

The slow-actuation mechanical liquid piston heat pump according to the invention comprises a circulating part of the working liquid which gives heat to the heating means via a heating secondary heat exchanger.

The slow-actuation mechanical liquid piston heat pump according to the invention comprises heat import means which are constituted of a circulating part of the working liquid, said part exiting from the expander liquid cylinder or from the expander gas and liquid reservoir via a liquid outlet duct to return into said volume or into said reservoir via a liquid inlet duct, this after having directly or indirectly taken the heat from the cooling means.

The slow-actuation mechanical liquid piston heat pump according to the invention comprises a circulating part of the working liquid which takes heat from the cooling means via a cooling secondary heat exchanger.

The slow-actuation mechanical liquid piston heat pump according to the invention comprises heat export means which are constituted of at least one heat exchanger duct housed in the compressor gas and liquid reservoir and in which a heat-transfer fluid circulates, which exports heat taken from the compressor heat exchange and accumulation means and/or to the working liquid and/or to the working gas contained in the compressor gas and liquid reservoir, on the other hand, to the heating means via heat transport ducts.

The slow-actuation mechanical liquid piston heat pump according to the invention comprises heat import means which are constituted of at least one heat exchanger conduit housed in the expander gas and liquid reservoir and in which circulates a heat transfer fluid which import heat from the cooling means to the expander heat exchange and accumulation means, on the one hand, and/or the working liquid and/or the working gas contained in the compressor gas and liquid reservoir, on the other hand, via heat transport ducts.

The slow-actuation mechanical liquid piston heat pump according to the invention comprises compressor heat exchange and accumulation means which are constituted of at least one liquid spray nozzle supplied by a liquid spray pump, said nozzle being able to atomise the working liquid into fine droplets in the internal volume of the compressor gas and liquid reservoir.

The slow-actuation mechanical liquid piston heat pump according to the invention comprises expander heat exchange and accumulation means which are constituted of at least one liquid spray nozzle supplied by a liquid spray pump, said nozzle being able to atomise the working liquid into fine droplets in the internal volume of the expander gas and liquid reservoir.

The slow-actuation mechanical liquid piston heat pump according to the invention comprises compressor heat exchange and accumulation means which are constituted of a rotary liquid atomizer which comprises a rotary atomizing cylinder pierced with radial atomizing orifices, an atomizer motor driving said cylinder in rapid rotation so that the latter sucks in working liquid at its axial end by centrifugation effect and/or by means of a pumping turbine, and radially rejects said liquid in the form of fine droplets into the internal volume of the compressor gas and liquid reservoir, via the radial atomizing orifices.

The slow-actuation mechanical liquid piston heat pump according to the invention comprises expander heat exchange and accumulation means which are constituted of a rotary liquid atomizer which comprises a rotary atomizing cylinder pierced with radial atomizing orifices, an atomizer motor driving said cylinder in rapid rotation so that the latter sucks in working liquid at its axial end by centrifugation effect and/or by means of a pumping turbine, and radially rejects said liquid in the form of fine droplets into the internal volume of the expander gas and liquid reservoir, via the radial atomizing orifices.

The slow-actuation mechanical liquid piston heat pump according to the invention comprises piston guiding means which are constituted of a sliding pivot connection formed between an external cylindrical surface that the connecting rod has, and a guiding orifice which is securely connected to the blind liquid cylinder.

The slow-actuation mechanical liquid piston heat pump according to the invention comprises piston guiding means which are constituted of a guiding skirt provided at the periphery of the double-acting hydraulic piston, said skirt being able to translate at a low clearance into said blind liquid cylinder.

The slow-actuation mechanical liquid piston heat pump according to the invention comprises compressor filling means and/or compressor draining means which are constituted of at least one compressor flap and/or at least one controlled compressor valve, while in operation, the working gas is expelled from the compressor gas and liquid reservoir via the compressor discharge plenum under a pressure greater than that under which it has been introduced beforehand into said reservoir via the compressor intake plenum.

The slow-actuation mechanical liquid piston heat pump according to the invention comprises expander filling means and/or expander draining means which are constituted of at least one expander controlled valve, while in operation, the working gas is expelled from the expander gas and liquid reservoir via the expander discharge plenum under a pressure less than that under which it has been introduced beforehand into said reservoir via the expander intake plenum.

The slow-actuation mechanical liquid piston heat pump according to the invention comprises a compressor discharge plenum which is connected to the expander intake plenum by a high-pressure gas duct so that the working gas exiting from the compressor pneumatic variable volume via said compressor discharge plenum is introduced into the expander pneumatic variable volume via said expander intake plenum, while the expander discharge plenum is connected to the compressor intake plenum by a low-pressure gas duct so that the working gas exiting from the expander pneumatic variable volume via said expander discharge plenum is introduced into the compressor pneumatic variable volume via said compressor intake plenum.

The slow-actuation mechanical liquid piston heat pump according to the invention comprises a high-pressure gas duct which communicates with at least one high-pressure gas reservoir.

The slow-actuation mechanical liquid piston heat pump according to the invention comprises a high-pressure gas duct which communicates with at least one high-pressure gas reservoir.

The slow-actuation mechanical liquid piston heat pump according to the invention comprises a working gas which circulates in the high-pressure gas duct which gives its heat to the working gas which circulates in the low-pressure gas duct via a regeneration heat exchanger.

The slow-actuation mechanical liquid piston heat pump according to the invention comprises a compressor intake plenum and a compressor discharge plenum which are positioned in the upper part of the compressor gas and liquid reservoir, the latter being itself positioned above the blind liquid cylinder, such that, due to the Earth's gravity, the working gas firstly always exits from the reservoir via the discharge plenum, and that the working liquid firstly always enters into said reservoir via the intake plenum.

The slow-actuation mechanical liquid piston heat pump according to the invention comprises an expander intake plenum and an expander discharge plenum which are positioned in the upper part of the expander gas and liquid reservoir, the latter being itself positioned above the blind liquid cylinder, such that, due to the Earth's gravity, the working gas firstly always exits from the reservoir via the discharge plenum, and that the working liquid firstly always enters into said reservoir via the intake plenum.

The slow-actuation mechanical liquid piston heat pump according to the invention comprises mechanical energy storage means which consist of a inertia flywheel made secured to the crankshaft by a transmission multiplier.

The slow-actuation mechanical liquid piston heat pump according to the invention comprises a crankshaft which comprises a ring gear which the drive motor drives in rotation by means of at least one ring drive pinion the primitive diameter of which is smaller than that of said ring, the latter and said pinion forming a multiplication gear system.

The slow-actuation mechanical liquid piston heat pump according to the invention comprises an overflow pump which can transfer working liquid from an overflow reservoir to and directly or not, the compressor gas and liquid reservoir and/or the compressor hydraulic variable volume and/or the communication duct which connects said reservoir to said variable volume, said overflow reservoir communicating with the compressor discharge plenum so that the working gas pressure which prevails in said reservoir is close to or identical to that which prevails in said plenum.

The slow-actuation mechanical liquid piston heat pump according to the invention comprises an overflow pump which can transfer working liquid from an overflow reservoir to and directly or not, the expander gas and liquid reservoir and/or the expander hydraulic variable volume and/or the communication duct which connects said reservoir to said variable volume, said overflow reservoir communicating with the expander discharge plenum so that the working gas pressure which prevails in said reservoir is close to or identical to that which prevails in said plenum.

The slow-actuation mechanical liquid piston heat pump according to the invention comprises an overflow pump which comprises a blind pump cylinder, in which an overflow pump piston can sealingly translate, the latter and said cylinder forming a variable overflow pump volume which, when it increases, is filled with working liquid coming from the overflow reservoir via at least one overflow pump intake flap and which, when it decreases, discharges said liquid successively via a discharge valve and a discharge duct.

The slow-actuation mechanical liquid piston heat pump according to the invention comprises an overflow pump piston which is a two-body staged piston which comprises a large-diameter body which has a large cross-section face which forms one of the walls of the variable overflow pump volume, said staged piston also comprising, axially opposite the large cross-section face, a small-diameter body which can sealingly translate into an actuation cylinder, the internal volume of which is connected directly, or not, to that of the discharge duct, said small-diameter body having a small cross-section face on which the pressure which prevails in the discharge duct is exerted, said staged piston also offering, at the junction between the large-diameter body and the small-diameter body, an average cross-section face from which the small-diameter body emerges, which is connected to the overflow reservoir, and which is subjected to the pressure in said reservoir, while a staged piston abutment set the maximum volume of the variable overflow pump volume and a two-body piston return spring tends to repel the two-body staged piston towards its large cross-section face.

The slow-actuation mechanical liquid piston heat pump according to the invention comprises a discharge valve which comprises a valve actuator piston which can sealingly translate into a valve actuator cylinder and which has, on the first hand, a valve actuation axial face which communicates with the overflow reservoir and on which the pressure prevailing in said reservoir is exerted, said face being able to raise an overflow flap from an overflow flap seat when the valve actuator piston is moved towards said face which has the effect of putting the variable overflow pump volume in communication with the discharge duct, and on the other hand, a discharge duct side axial face which communicates with the discharge duct, on which the pressure prevailing in said duct is exerted, and which can come into contact with a discharge duct side abutment when the valve actuator piston is moved towards said discharge duct side axial face, while an actuation piston return spring tends to repel the valve actuation piston towards its valve actuation axial face, and an overflow flap return spring tends to return the overflow flap in contact with the overflow flap seat with which it cooperates, the force that the actuation piston return spring produces being greater than the force that the overflow flap return spring produces.

The slow-actuation mechanical liquid piston heat pump according to the invention comprises an overflow pump piston which is a two-body staged piston which comprises a large-diameter body which has a large cross-section face which is connected to the overflow reservoir and which is subjected to the pressure prevailing in said reservoir, said staged piston also comprising, axially opposite the large cross-section face, a small-diameter body which can sealingly translate into an actuation cylinder, the internal volume of which is connected directly, or not, to the discharge duct, said small-diameter body, having a small cross-section face, on which the pressure prevailing in the discharge duct is exerted, said staged piston also offering, at the junction between the large-diameter body and the small-diameter body, an average cross-section face, from which the small-diameter body emerges, said face forming one of the walls of the variable overflow pump volume, while a staged piston abutment set the maximum volume of the variable overflow pump volume and a two-body piston return spring tends to repel the two-body staged piston towards its small cross-section face.

The slow-actuation mechanical liquid piston heat pump according to the invention comprises a discharge valve which comprises a valve actuator piston which can sealingly translate into a valve actuator cylinder and which has, on the one hand, a valve actuation axial face which communicates with the discharge duct and on which the pressure prevailing in said cylinder is exerted, said face being able to raise an overflow flap from an overflow flap seat when the valve actuator piston is moved towards said face which has the effect of putting the variable overflow pump volume in communication with the discharge duct, and on the other hand, a reservoir side axial face which communicates with the overflow reservoir, on which the pressure prevailing in said reservoir is exerted, and which can come into contact with an overflow reservoir side abutment when the valve actuator piston is moved towards said reservoir side axial face, while an actuation piston return spring tends to repel the valve actuator piston towards its valve actuation axial face, and an overflow flap return spring tends to return the overflow flap in contact with the overflow flap seat with which it cooperates, the force that the actuation piston return spring produces being greater than the force that the overflow flap return spring produces.

The slow-actuation mechanical liquid piston heat pump of the invention comprises a double-acting hydraulic piston that comprises at least two coaxial sealed disks that each have an axial piston face on the low-pressure side that communicates with the low-pressure gas duct.

The following description given by way of non-limiting examples and with reference to the accompanying drawings, makes it possible to understand the invention better, and to understand the features that it presents, and the advantages that it is likely to provide:

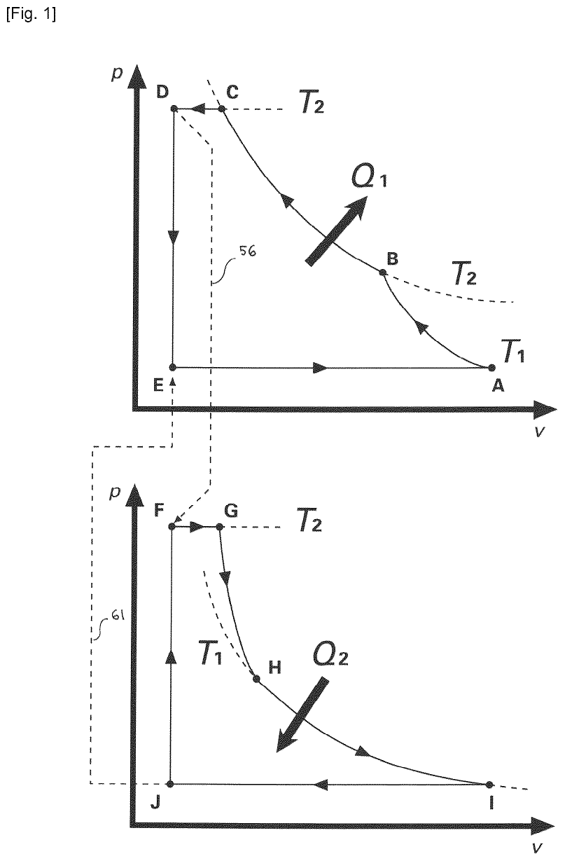

FIG. 1 is a pressure-volume diagram of the thermodynamic cycle executed by the slow-actuation mechanical liquid piston heat pump according to the invention when said pump is not equipped with a regeneration heat exchanger.

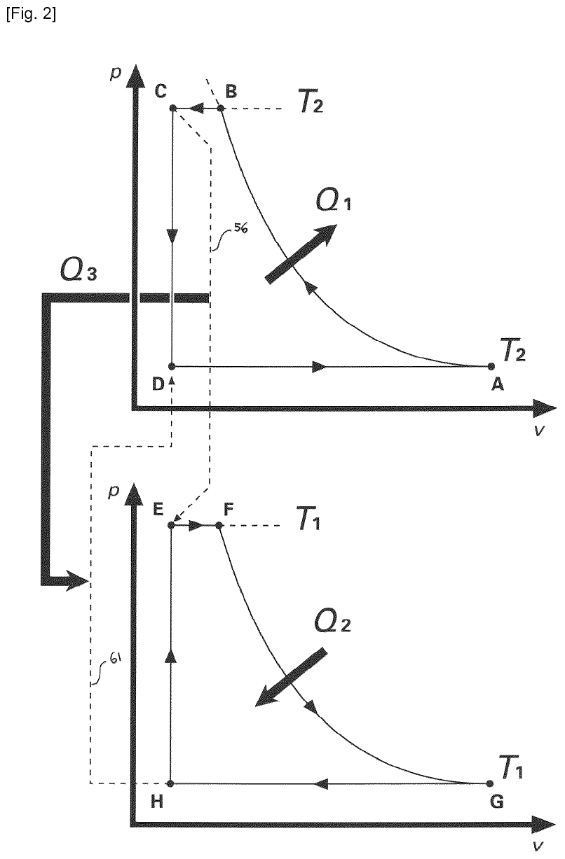

FIG. 2 is a pressure-volume diagram of the thermodynamic cycle executed by the slow-actuation mechanical liquid piston heat pump according to the invention when said pump is equipped with a regeneration heat exchanger.

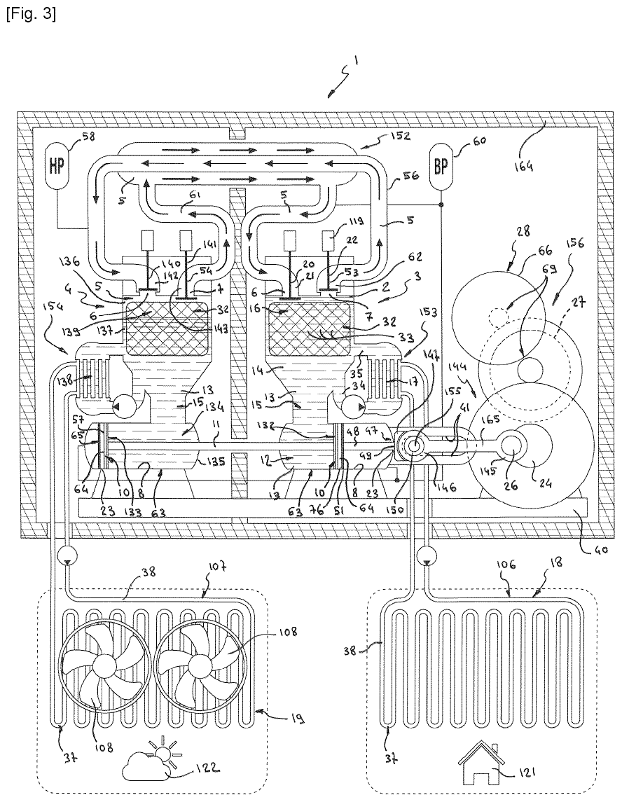

FIG. 3 is a schematic cross-sectional view of the slow-actuation mechanical liquid piston heat pump according to the invention, the blind liquid cylinder of which is formed of two coaxial cylindrical sections which each house a coaxial sealed disc of the double-acting hydraulic piston, and the connecting rod of which is connected to the connecting rod actuating means by the end of said rod, while a partitioned heat-insulating enclosure separates the compressor, the connecting rod actuating means, the drive motor and the mechanical energy storage means, on the one hand, from the expander, on the other hand, said enclosure also thermally separating said heat pump from the external environment.

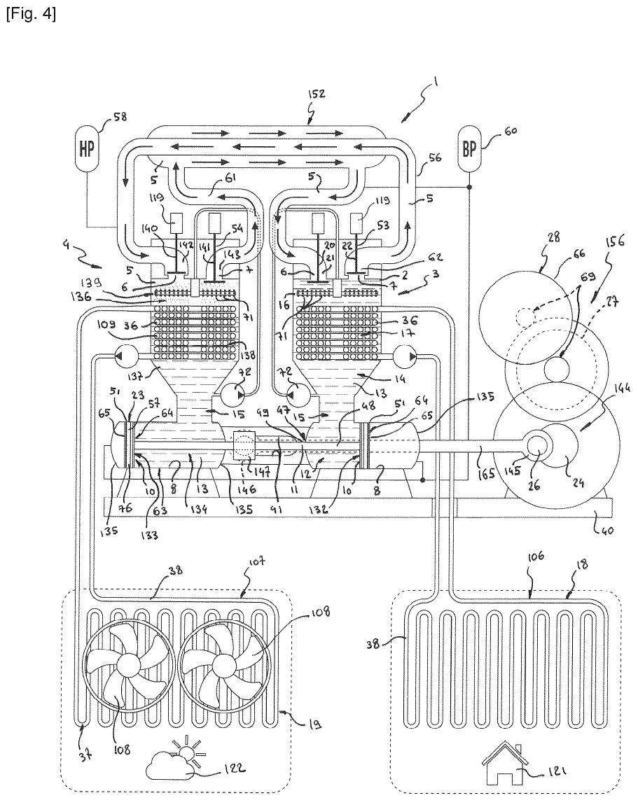

FIG. 4 is a schematic cross-sectional view of the slow-actuation mechanical liquid piston heat pump according to the invention, the blind liquid cylinder of which is formed of two coaxial cylindrical sections, each of which houses a coaxial sealed disc of the double-acting hydraulic piston and the connecting rod of which articulates with the connecting rod actuating means approximately in the middle of its length.

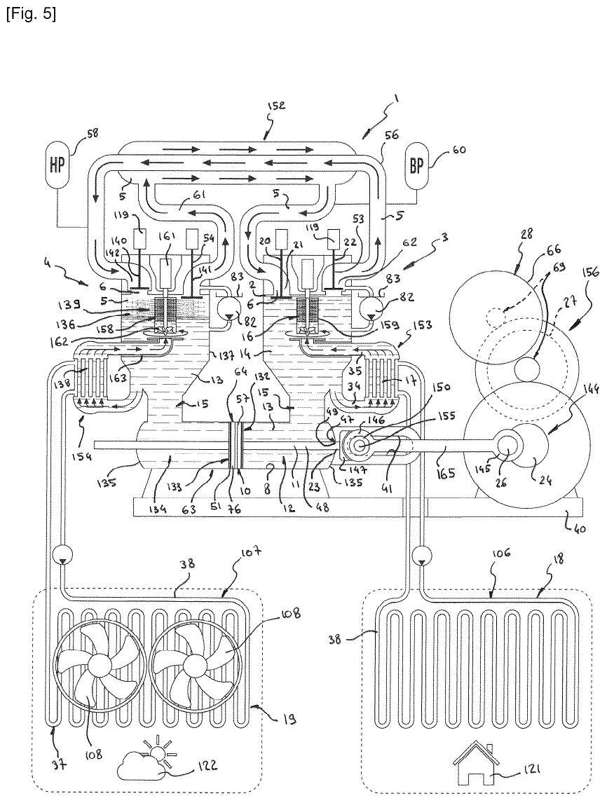

FIG. 5 is a schematic cross-sectional view of the slow-actuation mechanical liquid piston heat pump according to the invention, the blind liquid cylinder of which is formed of a single cylindrical section which houses a double-acting hydraulic piston which comprises a single coaxial sealed disc, the connecting rod being connected to the connecting rod actuating means by its end while the heat export means consist of a circulating part of the working liquid which leaves the compressor hydraulic variable volume, and the heat input means consist of a circulating part of the working liquid which leaves the expander hydraulic variable volume, the expander heat exchange and accumulation means and the expander heat exchange and accumulation means consisting of a rotary liquid atomizer.

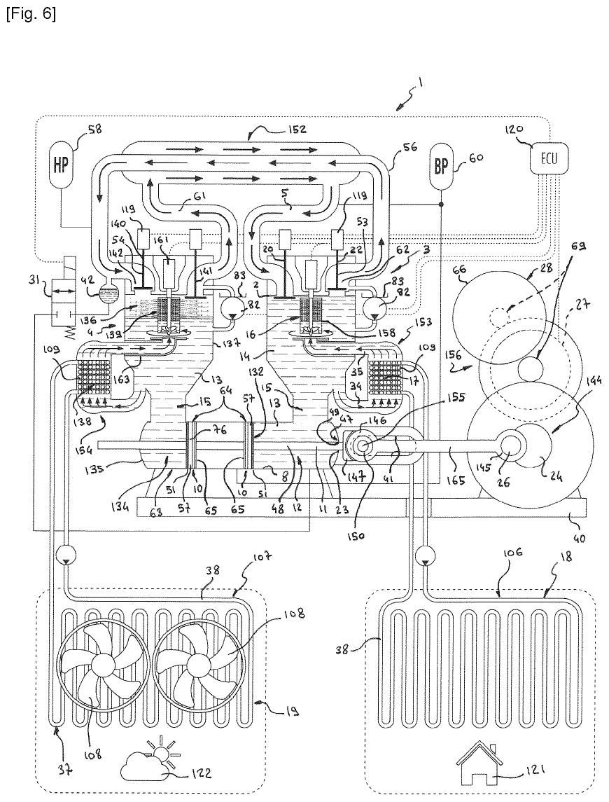

FIG. 6 is a schematic cross-sectional view of the slow-actuation mechanical liquid piston heat pump according to the invention and according to the variant shown in FIG. 5, except that the blind liquid cylinder houses a double-acting hydraulic piston which comprises two coaxial sealed discs which each has an low-pressure side axial piston face which communicates with the low-pressure gas duct, and which comprises a heating secondary heat exchanger and a cooling secondary heat exchanger consisting of a winding of copper pipe.

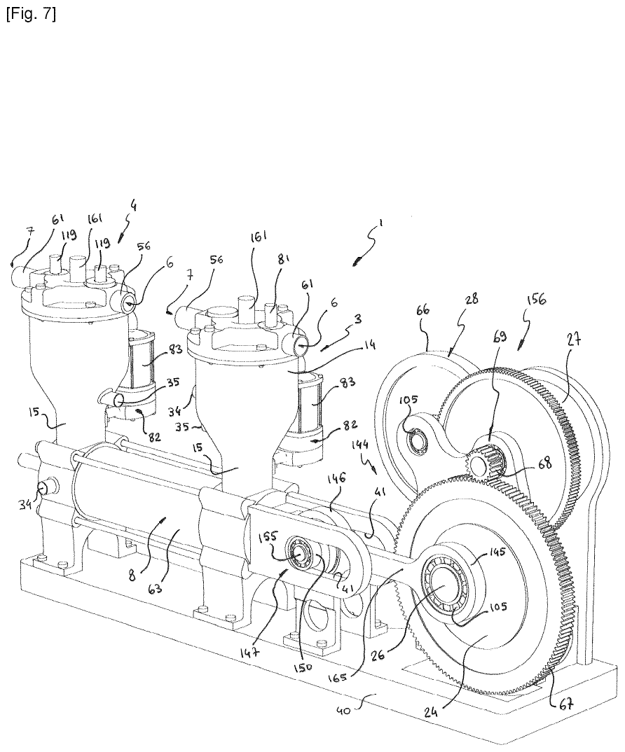

FIG. 7 is a three-dimensional view of the slow-actuation mechanical liquid piston heat pump according to the invention and according to the variant shown in FIG. 6, except in particular that the input ports and the output ports are reversed.

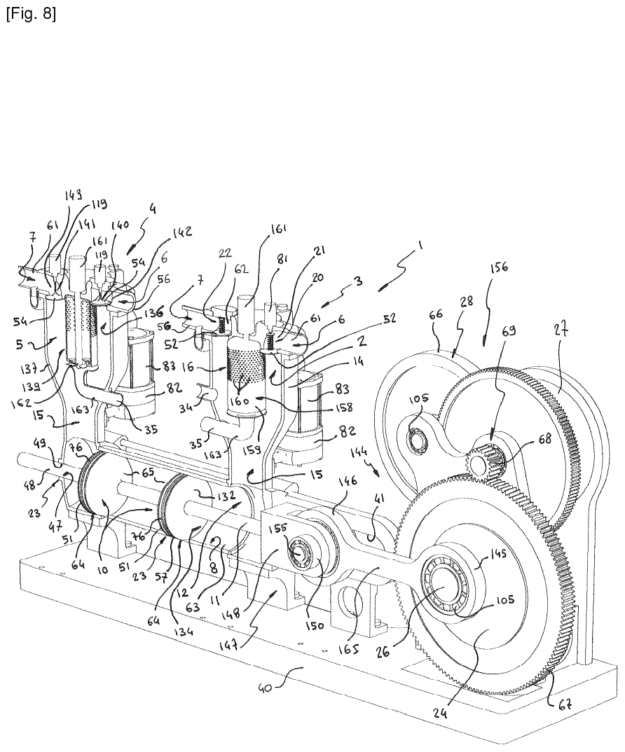

FIG. 8 is a three-dimensional view of the slow-actuation mechanical liquid piston heat pump according to the invention and according to the variant shown in FIG. 7, except in particular that the blind liquid cylinder, the compressor gas and liquid reservoir and the expander gas and liquid reservoir are cut off to show the contents.

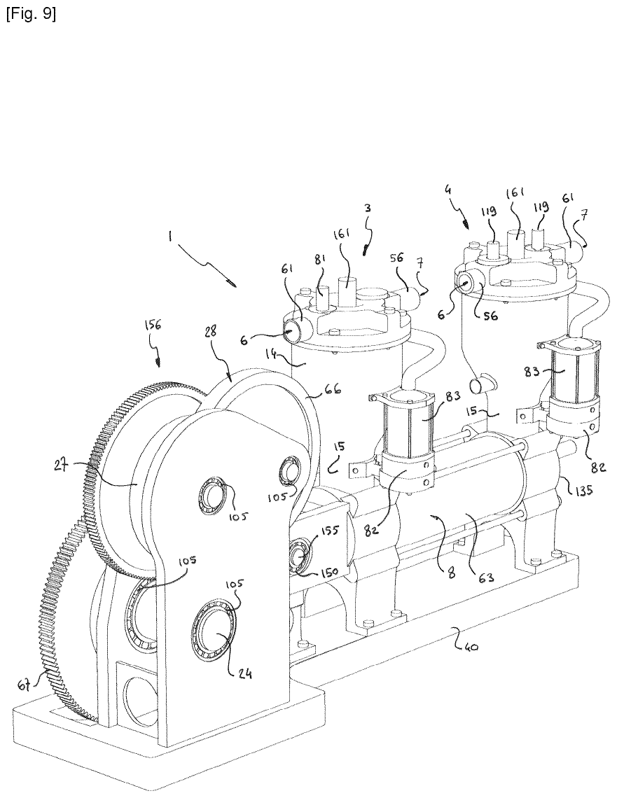

FIG. 9 is a three-dimensional view of the slow-actuation mechanical liquid piston heat pump according to the invention and according to the variant shown in FIG. 7, seen from the other side, so as to make clearly visible the overflow pump of the compressor, and that of the expander.

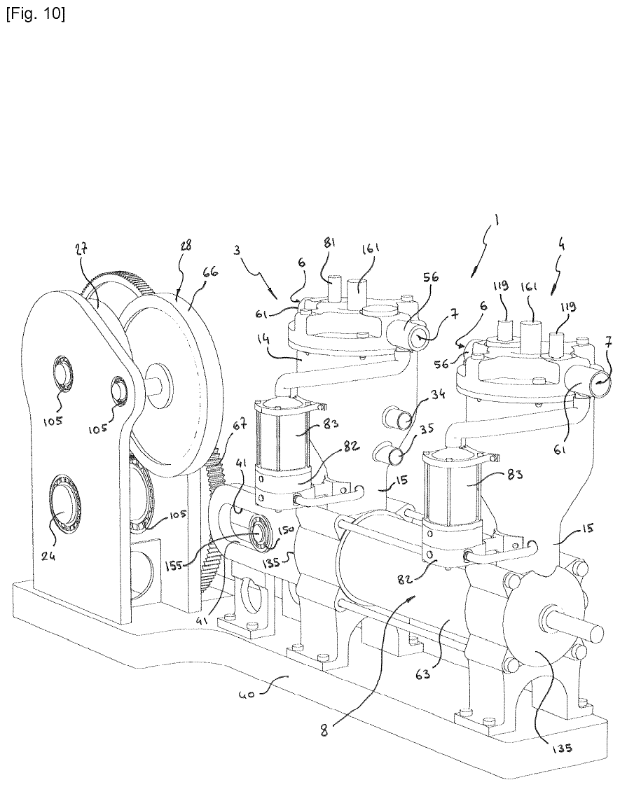

FIG. 10 is a three-dimensional view of the slow-actuation mechanical liquid piston heat pump according to the invention and according to the variant shown in FIG. 9, shown according to another angle of view.

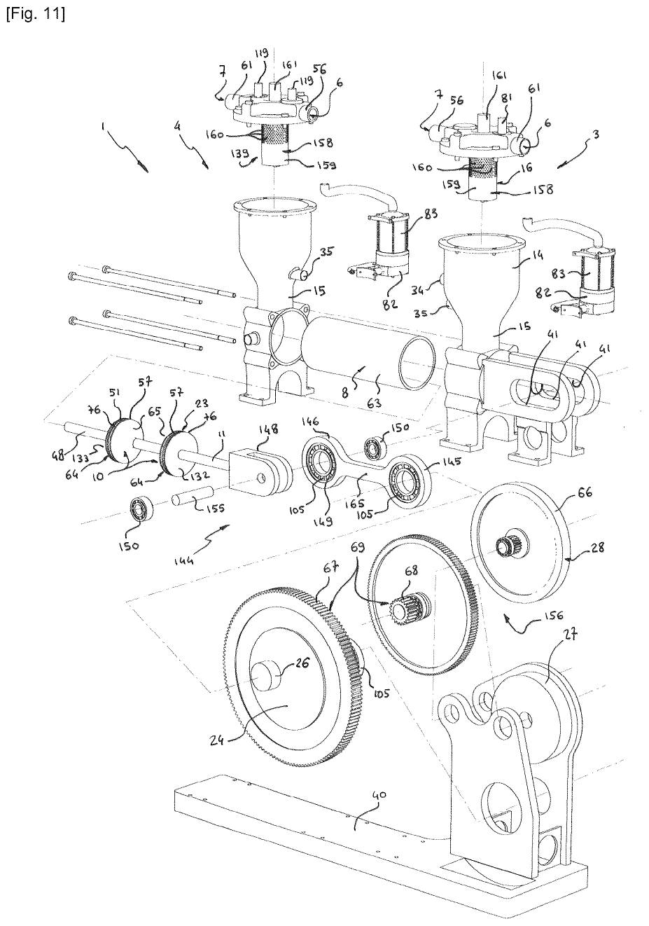

FIG. 11 is an exploded three-dimensional view of the slow-actuation mechanical liquid piston heat pump according to the invention and according to the variant shown in FIG. 7.

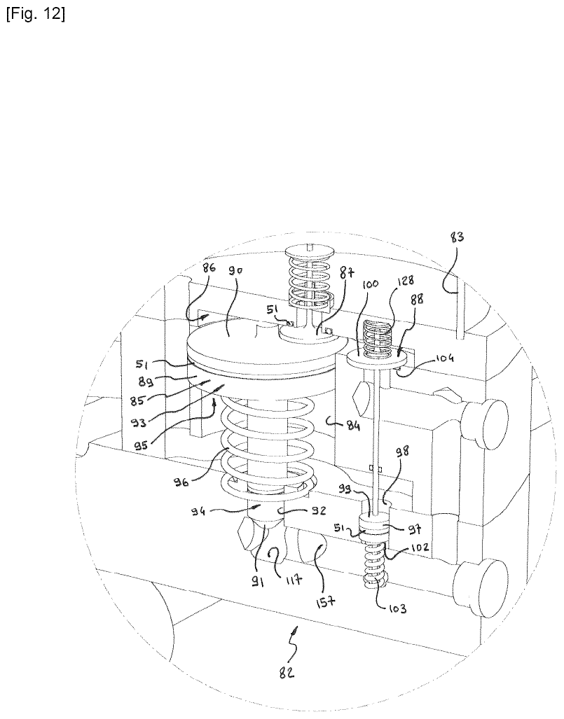

FIG. 12 is a three-dimensional cross-sectional view of an overflow pump as it may be provided for the compressor of the slow-actuation mechanical liquid piston heat pump according to the invention.

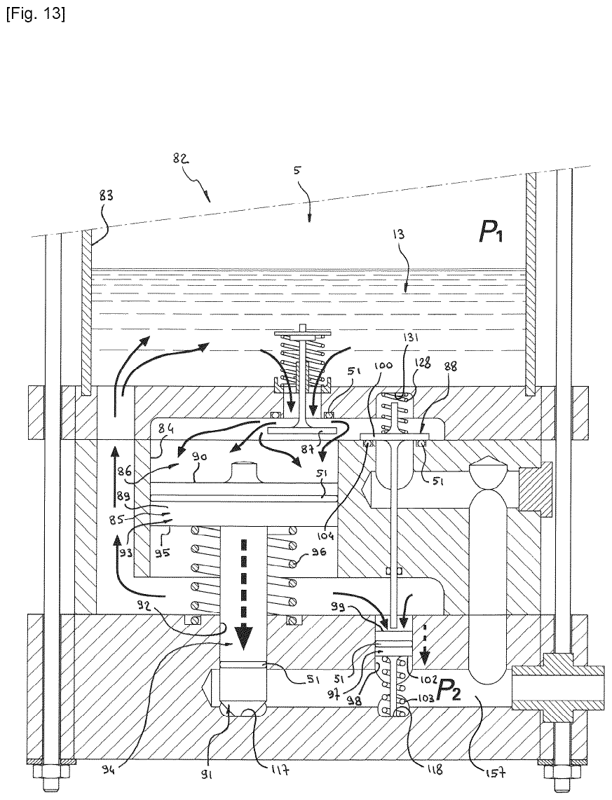

FIG. 13 is a schematic, cross-sectional view of the overflow pump shown in FIG. 12 of the slow-actuation mechanical liquid piston heat pump according to the invention, the pressure prevailing in the overflow reservoir of said pump being greater than the pressure in the discharge duct of said pump, which has the effect of filling the variable overflow pump volume with working liquid coming from said overflow reservoir.

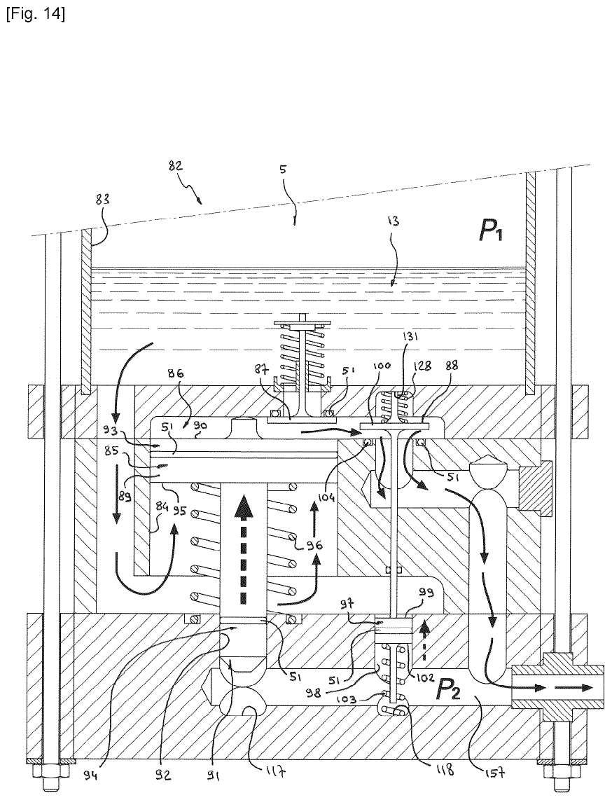

FIG. 14 is a schematic, cross-sectional view which shows what occurs after FIG. 13, when the pressure prevailing in the overflow reservoir of the overflow pump becomes substantially equal to the pressure in the discharge duct of said pump, which makes it possible for the two-body piston return spring to move the overflow pump piston to expel the working liquid taken in beforehand in the variable overflow pump volume to said discharge duct.

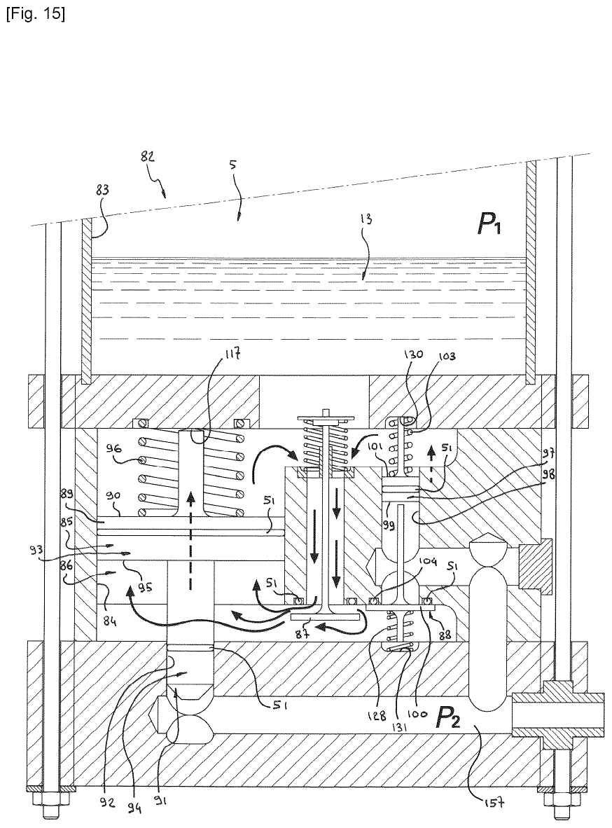

FIG. 15 is a schematic, cross-sectional view of an overflow pump as provided for the expander of the slow-actuation mechanical liquid piston heat pump according to the invention, the pressure prevailing in the overflow reservoir of said pump being lower than the pressure in the discharge duct of said pump, which has the effect of filling the variable overflow pump volume with working liquid coming from said overflow reservoir.

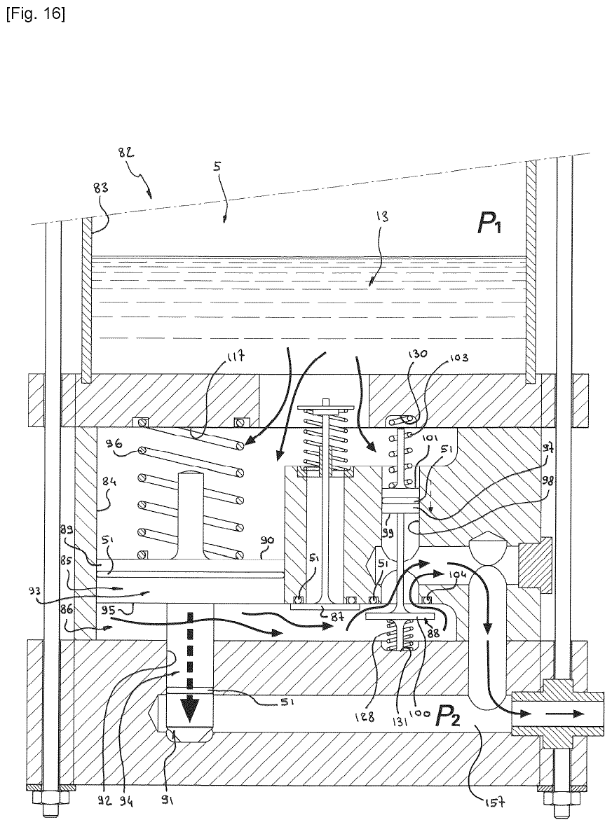

FIG. 16 is a schematic, cross-sectional view which shows what occurs after FIG. 15, when the pressure prevailing in the overflow reservoir of the overflow pump becomes substantially equal to the pressure prevailing in the discharge duct of said pump, which makes it possible for the two-body piston return spring to move the overflow pump piston to expel the working liquid taken in beforehand in the variable overflow pump volume to said discharge duct.

### DESCRIPTION OF THE INVENTION

In FIGS. 1 to 16, the slow-actuation mechanical liquid piston heat pump 1 according to the invention, various details of its components, its variants, and its accessories have been shown.

As can be seen in FIGS. 3 to 11, the slow-actuation mechanical liquid piston heat pump 1 according to the invention comprises a compressor 3 in which a compressor pneumatic variable volume 2 is formed, and an expander 4 in which an expander pneumatic variable volume 136 is formed.

Each said volume 2, 136 comprises, on the one hand, an inlet port 6 through which a working gas 5 can enter and, on the other hand, an outlet port 7 through which said gas 5 can exit.

In addition, FIGS. 3 to 11 illustrate that the slow-actuation mechanical liquid piston heat pump 1 according to the invention also comprises at least one blind liquid cylinder 8 which is formed of one or more coaxial cylindrical sections 63.

The blind liquid cylinder 8 is directly or indirectly secured to a static frame 40 and comprises at least two ends which are each closed by a sealed cylinder termination 135.

A double-acting hydraulic piston 10 shown in FIGS. 3 to 6 and in FIGS. 8 and 11 can translate in a sealed manner in the blind liquid cylinder 8, said piston 10 comprising one or more coaxial sealed discs 64 and having, on the one hand, at least one compressor side axial piston face 132 which forms, with said cylinder 8 and a sealed cylinder termination 135, a compressor hydraulic variable volume 12, and, on the other hand, at least one expander side axial piston face 133 which forms, with said cylinder 8 and another sealed cylinder termination 135, a expander hydraulic variable volume 134, the two said hydraulic variable volumes 12, 133 being completely or partially filled with a working liquid 13.

It is noted in FIGS. 3 to 6, in FIG. 8 and in FIGS. 10 to 11, that the hydraulic piston 10 can advantageously comprise at least one seal 51, whether the latter is an O-ring, a lip seal, composite seal, or of a type known to a person skilled in the art, said seal 51 prohibiting working liquid 13 from leaking between said piston 10 and the liquid cylinder 8.

Alternatively to said seal 51, at least one cutting or continuous segment can form a sealing between the double-acting hydraulic piston 10 and the blind liquid cylinder 8.

The double-acting hydraulic piston 10 can also comprise an antifriction guiding ring 76 preferably made of an abrasion-resistant material such as polytetrafluoroethylene loaded with antifriction particles such as graphite, said ring 76 guiding and centring said piston 10 in the blind liquid cylinder 8.

By way of example, the working liquid 13 can be constituted by pure water, or water to which glycol has been added to lower the solidification temperature of said water.

It will be noted that the static frame 40 can be fixed or placed on the floor of a residential, commercial or industrial building 121, while the working gas 5 can be atmospheric air and be constituted of any element or molecule such as pure nitrogen, helium, argon, or carbon dioxide, said element or molecule being chosen according to its chemical reactivity, its thermodynamic performance, and its ability to promote heat exchanges in particular with the working liquid 13 and with the compressor heat exchange and accumulation means 16 and the expander heat exchange and accumulation means 139.

This also makes it possible to prevent the corrosion of the inner components of the slow-actuation mechanical liquid piston heat pump 1 according to the invention, and the development of microorganisms.

As shown in FIGS. 3 to 11, the slow-actuation mechanical liquid piston heat pump 1 according to the invention also comprises a compressor gas and liquid reservoir 14 that is connected to the compressor hydraulic variable volume 12 by a communication duct 15, such that said reservoir 14 is mainly or totally filled with working liquid 13 when the compressor hydraulic variable volume 12 is minimum, said reservoir 14 being partially or totally filled with working gas 5 when the compressor hydraulic variable volume 12 is maximum.

The variation in the volume of the working gas 5 contained in the compressor gas and liquid reservoir 14 defines, on the one hand, the compressor pneumatic variable volume 2 and is, on the other hand, approximately equal to the variation in the volume of the working liquid 13 contained in the compressor hydraulic variable volume 12 according to the principle of communicating vessels.

In the same FIGS. 3 to 11, it has also been shown that the slow-actuation mechanical liquid piston heat pump 1 according to the invention also comprises an expander gas and liquid reservoir 137 which is connected to the expander hydraulic variable volume 134 by a communication duct 15, such that said reservoir 137 is mainly or totally filled with working liquid 13 when the expander hydraulic variable volume 134 is minimum, said reservoir 137 being partially or totally filled with working gas 5 when the expander hydraulic variable volume 134 is maximum.

The variation in the volume of the working gas 5 contained in the expander gas and liquid reservoir 137 defines, on the one hand, the expander pneumatic variable volume 136 and, on the other hand, is approximately equal to the variation in the volume of the working liquid 13 contained in the expander hydraulic variable volume 134.

It should be noted that the maximum acceleration and deceleration to which the working liquid 13 contained in the compressor gas and liquid reservoir 14 and the expander gas and liquid reservoir 137 are subjected must preferably remain less than that of the Earth's gravity, so that said liquid 13 is not subjected to any phenomenon of cavitation or excessive mixing with the working gas 5 which is also contained in said reservoirs 14, 137.

It is also noted that a passivator in the form of a perforated or bent sheet or a permeable or non-permeable solid structure may be provided in the compressor gas and liquid reservoir 14 and/or the expander gas and liquid reservoir 137, in order to avoid excessive turbulence of the working liquid 13 contained in said reservoirs 14, 137.

As can be seen in FIGS. 3 to 6 and in FIGS. 8 and 11, the slow-actuation mechanical liquid piston heat pump 1 according to the invention further comprises compressor heat exchange and accumulation means 16 that are housed in the compressor gas and liquid reservoir 14, said means 16 being able mainly to take heat from the working gas 5 contained in said reservoir 14 and temporarily store said heat, before giving the latter to the working liquid 13 also contained in said reservoir 14.

In the same figures, it can be seen that said heat pump 1 also comprises expander heat exchange and accumulation means 139 that are housed in the expander gas and liquid reservoir 137, said means 139 being able to mainly take heat from the working liquid 13 that said reservoir 137 contains and temporarily store said heat, before giving the latter to the working gas 5 that said reservoir 137 also contains.

Particularly in FIGS. 3 to 6, it is noted that the slow-actuation mechanical liquid piston heat pump 1 according to the invention comprises heat export means 17 housed inside and/or outside the compressor gas and liquid reservoir 14, said means 17 directly or indirectly taking heat from the compressor heat exchange and accumulation means 16 on the one hand, and/or from the working liquid 13 and/or or from the working gas 5 contained in whole or in part in said reservoir 14, said heat then being given to heating means 18 external to the compressor gas and liquid reservoir 14 which may take the form of a cooling-heating floor 106 arranged in a commercial or residential building 121, or of a fan-convector known per se, or of an air-water exchanger 107 placed on the outside 122 of said building 121, and through which atmospheric air is forced to pass through at least one motor fan 108, soil-water or water-water arranged on the outside 122, according to the principles ordinarily retained for aerothermic or geothermic heat pumps.

Similarly, the slow-actuation mechanical liquid piston heat pump 1 according to the invention comprises heat import means 138 housed inside and/or outside the expander gas and liquid reservoir 137, said means 138 directly or indirectly supplying heat to the expander heat exchange and accumulation means 39 on the one hand, and/or to the working liquid 13 and/or to the working gas 5 contained in whole or in part in said reservoir 137 on the other hand, said heat having been previously taken from cooling means 19 external to the expander gas and liquid reservoir 137 which may take the form of a cooling-heating floor 106 arranged in a commercial or residential building 121, or of a fan coil unit known per se, or of an air-water exchanger 107, soil-water or water-water arranged on the outside 122, according to the principles ordinarily retained for aerothermal or geothermal heat pumps.

As can be seen in FIGS. 3 to 6 and in FIG. 8, the slow-actuation mechanical liquid piston heat pump 1 according to the invention also comprises compressor filling means 20 which enable or prohibit the passage of working gas 5 from a compressor intake plenum 21 to the compressor gas and liquid reservoir 14 via the inlet port 6 of the compressor 3.

In the same said figures, it is noted that said heat pump 1 also comprises compressor draining means 22 that allow or prevent the passage of working gas 5 from the compressor gas and liquid reservoir 14 to a compressor discharge plenum 62 via the outlet port 7 of the compressor 3.

As can be always seen in FIGS. 3 to 6 and in FIG. 8, expander filling means 140 enable or prohibit the passage of working gas 5 from an expander intake plenum 142 to the expander gas and liquid reservoir 137 via the inlet port 6 of the expander 4.

The same said figures also show that expander draining means 141 enable or prohibit the passage of working gas 5 from the expander gas and liquid reservoir 137 to an expander discharge plenum 143 via the outlet port 7 of the expander 4.

In FIGS. 3 to 6 and in FIGS. 8 and 11, it has been shown that the slow-actuation mechanical liquid piston heat pump 1 according to the invention comprises a connecting rod 11 which is secured to the double-acting hydraulic piston 10, which passes in a sealed manner through at least one of the ends of the blind liquid cylinder 8, and which is approximately parallel to the longitudinal axis of said piston 10 and of the blind liquid cylinder 8.

FIGS. 3 to 6 and in FIG. 8 show that piston guiding means 23 maintain the hydraulic piston 10 and the connecting rod 11 parallel to the blind liquid cylinder 8, whatever the position of said piston 10 in said cylinder 8.

In FIGS. 3 to 11, it has been illustrated that the slow-actuation mechanical liquid piston heat pump 1 according to the invention also comprises connecting rod actuation means 144 by means of which a drive motor 27 imparts to the connecting rod 11 a longitudinal reciprocating translational movement parallel to the axis of the blind liquid cylinder 8, said motor 27 possibly being electric, thermal with internal or external combustion, hydraulic, pneumatic, or of any type known to the person skilled in the art.

FIGS. 3 to 11 finally show that said piston heat pump 1 according to the invention also comprises mechanical energy storage means 28 which are inertial, pneumatic, electrical, gravitational, or of any known or future type, which are directly or indirectly connected to the connecting rod actuating means 144 and/or to the connecting rod 11 itself, said storage means 28 being able alternatively to take and to give mechanical energy from/to said actuating means 144 and/or from/to said rod 11.

FIGS. 3 to 11 show that according to a variant of the slow-actuation mechanical liquid piston heat pump 1 according to the invention, the connecting rod actuating means 144 can consist of a crankshaft 24 which is oriented perpendicularly to the blind liquid cylinder 8, and which can rotate in at least one shaft bearing 25 which is directly or indirectly secured to the static frame 40.

According to said variant, the crankshaft 24 may have at least one crank 26 around which a rod head 145 of an actuating rod 165 is articulated, the latter also comprising a rod foot 146 which is articulated with the connecting rod 11, the latter passing in a sealed manner through at least one of the sealed cylinder terminations 135.

It should be noted that the shaft bearing 25, the rod head 145, and the rod foot 146 can receive a roller bearing 105, a ball bearing or a needle bearing known per se.

In the context of the variant that has just been described, it can be seen in FIGS. 3 to 11 that the rod foot 146 can be articulated with the connecting rod 11 by means of a low-friction connecting crosshead 147, which is secured to said connecting rod 11.

In this case, the connecting crosshead 147 may comprise a crosshead yoke 148 which is traversed by a crosshead axis 155 which is perpendicular to the connecting rod 11 and about which are articulated, on the one hand, a rod foot bearing 149 which comprises the rod foot 146 and which may advantageously consist of a ball or roller bearing known per se, and at least one crosshead roller 150 with balls or rollers known per se which rolls on at least one crosshead raceway 41 which is parallel to the blind liquid cylinder 8, and which is directly or indirectly secured to said cylinder 8.

As a technological equivalent, the yoke may be secured to the actuating rod 146 in place of the rod foot 146, while the connecting rod 11 may receive a bearing or a rolling bearing.

It will be noted that the radial forces to which the crosshead roller 150 is subjected are a part of the axial force that the actuating rod 165 receives when the latter is not perfectly parallel to the blind liquid cylinder 8.

According to another variant of the slow-actuation mechanical liquid piston heat pump 1 according to the invention, the double-acting hydraulic piston 10 can consist of two coaxial sealed discs 64 which are axially sufficiently distant from each other to leave a portion of the blind liquid cylinder 8 not swept by said piston 10 as clearly shown in FIGS. 6 and 8.

As has been shown in FIG. 3, the compressor heat exchange and accumulation means 16 and/or the expander heat exchange and accumulation means 139 can be constituted of a porous medium 32 which has porosities 33 into which and from which the working liquid 13 and the working gas 5 alternatively enter and exit.

As an example, said porous medium 32 can be constituted of porous ceramic, of a ceramic or metal structure, or of a metallic wool made of copper or aluminium.

As a variant of the slow-actuation mechanical liquid piston heat pump 1 according to the invention shown in FIGS. 3, 5 and 6, the heat export means 17 may consist of a circulating part of the working liquid 13 which leaves the compressor hydraulic variable volume 12 and/or the compressor gas and liquid reservoir 14 via a liquid outlet duct 34 and then returns to said volume 12 and/or to said reservoir 14 via a liquid inlet duct 35, this after having directly or indirectly given heat to the heating means 18.

According to this last variant, the circulating part of the working liquid 13 can give heat to the heating means 18 via a heating secondary heat exchanger 153 which can be with plates, tubular, or of any type known to the person skilled in the art.

Similarly and as also shown in FIGS. 3, 5 and 6, the heat import means 138 can be constituted of a circulating part of the working liquid 13 which leaves the expander hydraulic variable volume 134 and/or the expander gas and liquid reservoir 137 via a liquid outlet duct 34 and then returns to said volume 134 and/or to said reservoir 137 via a liquid inlet duct 35, this after having directly or indirectly taken heat from the cooling means 19.

In this case, the circulating part of the working liquid 13 can take heat from the cooling means 19 via a cooling secondary heat exchanger 154 which can be with plates, tubular, or of any type known to the person skilled in the art.

In FIG. 4 and according to another variant of the slow-actuation mechanical liquid piston heat pump 1 according to the invention, it has been shown that the heat export means 17 can consist of at least one heat exchanger duct 36 housed in the compressor gas and liquid reservoir 14 and in which circulates a heat transfer fluid 37 which exports heat taken from the compressor heat exchange and accumulation means 16, on the one hand, and/or from the working liquid 13 and/or from the working gas 5 contained in the compressor gas and liquid reservoir 14, on the other hand, to the heating means 18, via heat transport ducts 38.

In the same FIG. 4, it can be seen that, similarly, the heat import means 138 can consist of at least one heat exchanger duct 36 housed in the expander gas and liquid reservoir 137 and in which circulates a heat transfer fluid 37 which imports heat from the cooling means 19 to the expander heat exchange and accumulation means 139, on the one hand, and/or the working liquid 13 and/or the working gas 5 contained in the compressor gas and liquid reservoir 14, on the other hand, via heat transport ducts 38.

It should be noted that the heat exchanger duct 36 can, depending on the case, form in itself the compressor heat exchange and accumulation means 16 or the expander heat exchange and accumulation means 139.

By way of non-limiting example, the heat exchanger duct 36 may take the form of a winding 109 of copper or aluminium pipe, while the heat transport ducts 38 may be coated with a thermal insulation.

It is noted that the turns or the layers that the heat exchanger duct 36 can constitute, can be maintained in place in the compressor gas and liquid reservoir 14 or in the expander gas and liquid reservoir 137 and against one another by maintaining plates or by separation baffles which can constitute chicanes and/or passage restrictions creating working liquid 13 and/or working gas 5 jets during the passage of said liquid 13 and/or of said gas 5 through said restrictions.

Furthermore, the heat exchanger duct 36 can receive external fins which increase its contact surface with the working liquid 13 or the working gas 5.

FIG. 4 shows that according to another variant of the slow-actuation mechanical liquid piston heat pump according to claim 1, the heat exchange and accumulation means 16 can be constituted of at least one liquid spray nozzle 71 supplied by a liquid spray pump 72, said nozzle 71 being able to atomise the working liquid 13 into fine droplets in the internal volume of the compressor gas and liquid reservoir 14.

Similarly and always in FIG. 4, it is noted that the heat exchange and accumulation means 139 can be constituted of at least one liquid spray nozzle 71 supplied by a liquid spray pump 72, said nozzle 71 being able to atomise the working liquid 13 into fine droplets in the internal volume of the expander gas and liquid reservoir (137).

It is noted that, whether it is the compressor 3 or the expander 4, the number, position, and orientation of the nozzles 71 are not limited and are provided so that the atomized working liquid 13 exposes to the working gas 5 a large developed heat exchange surface, while the speed of entrainment of said gas 5 by said liquid 13 also promotes as much as possible the heat exchanges between said gas 5 and said liquid 13.

It is also noted that the liquid spray pump 72 can have one or more pistons, can be a gear pump, a turbine pump or of a type known by a person skilled in the art, and be housed inside or outside of the compressor gas and liquid reservoir 14 or of the expander gas and liquid reservoir 137.

The liquid spray pump 72 can, for example, by constituted of a piston which is directly or indirectly moved by a cam rotated by the crankshaft 24, the profile of said cam being calculated, such that the atomisation of the working liquid 13 starts at the suitable angular rotation moment of said shaft 24, and for an optimal angular duration and according to an optimal intensity variation law.

It is noted that preferably, the liquid spray pump 72 sucks in working liquid 13 from the same volume than that in which it discharges said liquid 13 via the liquid spray nozzle 71, such that the pressure difference between the intake and the discharge of said pump 72 is minimum.

As a particular configuration of the slow-actuation mechanical liquid piston heat pump 1 according to the invention, it has been shown visibly in FIGS. 5, 6, 8 and 11 that the compressor heat exchange and accumulation means 16 can be constituted of a rotary liquid atomizer 158 which comprises a rotary atomization cylinder 159 pierced with radial atomization orifices 160, an atomizer motor 161 driving said cylinder 159 in rapid rotation so that the latter sucks in working liquid 13 at its axial end by centrifugation effect and/or by means of a pumping turbine 162, and radially rejects said liquid 13 in the form of fine droplets into the internal volume of the compressor gas and liquid reservoir 14, via the radial atomization orifices 160.

Still in FIGS. 5, 6, 8 and 11, it has also been shown that the expander heat exchange and accumulation means 139 can be constituted of a rotary liquid atomizer 158 which comprises a rotary atomization cylinder 159 pierced with radial atomization orifices 160, an atomizer motor 161 driving said cylinder 159 in rapid rotation so that the latter sucks in working liquid 13 at its axial end by centrifugation effect and/or by means of a pumping turbine 162, and radially rejects said liquid 13 in the form of fine droplets into the internal volume of the expander gas and liquid reservoir 137, via the radial atomization orifices 160.

As can be seen in FIGS. 5, 6 and 8, a portion of the working liquid 13 sucked in by the axial end of the rotary atomizing cylinder 159 can come from a suction sleeve 163 connected, as the case may be, either to a heating secondary heat exchanger 153 or to a cooling secondary heat exchanger 154.

This particular configuration of the slow-actuation mechanical liquid piston heat pump 1 according to the invention avoids to resort to an additional circulator to circulate the working liquid 13 through said secondary exchangers 153, 154, and makes it possible to increase the temperature difference between said liquid 13 and the working gas 5 at the time of atomization of said liquid 13 either in the internal volume of the compressor gas and liquid reservoir 14, or in the internal volume of the expander gas and liquid reservoir 137.

As can be seen in FIGS. 1 to 3 and in FIG. 8, the piston guiding means 23 can be constituted of a sliding pivot connection 47 formed between an external cylindrical surface 48 that the connecting rod 11 has, and a guiding orifice 49 which is securely connected to the blind liquid cylinder 8 by way or not of a ring carrier structure.

As shown in FIGS. 3 to 6 and 8 to 11, it has been shown that the piston guiding means 23 can be constituted of a guiding skirt (57) provided at the periphery of the double-acting hydraulic piston (10), said skirt (57) being able to translate at a low clearance into said blind liquid cylinder (8).

It has also been shown in FIGS. 3 to 6 and 8 that the compressor filling means 20 and/or the compressor draining means 22 can be constituted of at least one compressor flap 52 and/or of at least one controlled compressor valve 53, while in operation, the working gas 5 is expelled from the compressor gas and liquid reservoir 14 via the compressor discharge plenum 62 under a pressure greater than that under which it has been introduced beforehand in said reservoir 14 via the compressor intake plenum 21.

It is noted that the compressor flap 52 can be formed of a single strip or contact part returned on a sealed seat by a spring, whatever its type, or be formed of a valve assisted by an electromechanical actuator which cooperates with at least one pressure switch or with a pressure sensor coupled with a computer 120.

It should also be noted that a flap opening holding actuator 81 can be provided that prevents the reclosing of at least one compressor flap 52 to allow the slow-actuation mechanical liquid piston heat pump 1 according to the invention to be started.

It has been shown in FIGS. 3 to 6 and 8 that the expander filling means 140 and/or the expander draining means 141 can be constituted of at least one controlled expander valve 54, while in operation, the working gas 5 is expelled from the expander gas and liquid reservoir 137 via the expander discharge plenum 143 under a pressure less than that under which it has been introduced beforehand in said reservoir 137 via the expander intake plenum 21.

It should be noted that the outlet ports 7 of the compressor 3 and/or of the expander 4 can advantageously form a small working liquid reservoir 13 such that the compressor flaps 52, the controlled compressor valves 53 and the controlled expander valves 54 remain partially or totally immersed in the working liquid 13 when they are reclosed.

As can be seen particularly in FIGS. 3 to 6, the compressor discharge plenum 62 can be connected to the expander intake plenum 142 through a high-pressure gas duct 56 so that the working gas 5 exiting from the compressor pneumatic variable volume 2 via said compressor discharge plenum 62 is introduced into the expander pneumatic variable volume 136 via said expander intake plenum 142, while the expander discharge plenum 143 can be connected to the compressor intake plenum 21 through a low-pressure gas duct 61 so that the working gas 5 exiting from the expander pneumatic variable volume 136 via said expander discharge plenum 143 is introduced into the compressor pneumatic variable volume 2 via said compressor intake plenum 21.

FIGS. 3 to 6 clearly show that the high-pressure gas duct 56 can communicate with at least one high-pressure gas reservoir 58.

As a variant shown in FIGS. 3 to 6, the low-pressure gas duct 61 may similarly communicate with at least one low-pressure gas reservoir 60.

It should be noted that a regeneration heat exchanger 152 as shown in FIGS. 3 to 6 can constitute in itself all or part of the high-pressure gas reservoir 58 and/or the low-pressure gas reservoir 60, while according to a particular embodiment of the slow-actuation mechanical liquid piston heat pump 1 according to the invention, the volume of said reservoirs 58, 60 can be settable by intrusion of a solid or a liquid into said reservoirs 58, 60.

According to a variant of the slow-actuation mechanical liquid piston heat pump 1 according to the invention shown in FIGS. 3 to 6, the working gas 5 which circulates in the high-pressure gas duct 56 can give its heat to the working gas 5 which circulates in the low-pressure gas duct 61 by means of a regeneration heat exchanger 152, preferably countercurrentwise, said exchanger 152 possibly being of the type with plates, tubes, or any type known to the person skilled in the art.

It should be noted that the internal volume of the regeneration heat exchanger 152 may in itself constitute a high-pressure gas reservoir 58 and/or a low-pressure gas reservoir 60.

As is clearly illustrated in FIGS. 3 to 6, the compressor intake plenum 21 and the compressor discharge plenum 62 can advantageously be positioned in the upper part of the compressor gas and liquid reservoir 14, the latter itself being positioned above the blind liquid cylinder 8, such that due to the Earth's gravity, the working gas 5 always exits firstly from said reservoir 14 via the discharge plenum 62, and that the working liquid 13 always enters firstly in said reservoir 14 via the intake plenum 21.

Thus, the working liquid 13 always remains essentially below the working gas 5 in the compressor gas and liquid reservoir 14, even if said liquid 13 may contain a certain proportion of said gas 5 dissolved or in the form of bubbles.

Similarly, FIGS. 3 to 6 show that the expander intake plenum 142 and the expander discharge plenum 143 can advantageously be positioned in the upper part of the expander gas and liquid reservoir 137, the latter being itself positioned above the blind liquid cylinder 8, such that, due to the Earth's gravity, the working gas 5 firstly always exits from the reservoir 137 via the discharge plenum 143, and that the working liquid 13 firstly always enters into said reservoir 137 via the intake plenum 142.

Thus, the working liquid 13 always remains essentially below the working gas 5 in the expander gas and liquid reservoir 137, even if said liquid 13 may contain a certain proportion of said gas 5 dissolved or in the form of bubbles.

As has been shown in FIGS. 3 to 11, the mechanical energy storage means 28 can consist of an inertia flywheel 66 made secured in rotation to the crankshaft 24 by a transmission multiplier 156 with gear, chain, belt, hydraulic, electric or any type known to the person skilled in the art, so that said inertia flywheel 66 rotates significantly faster than the crankshaft 24.

According to this particular configuration of the slow-actuation mechanical liquid piston heat pump 1 according to the invention, the instant torque variations that the compression or the expansion of the working gas 5 in the compressor gas and liquid reservoir 14 imposes on the crankshaft 24, are mainly absorbed by the inertia of the inertia flywheel 66, such that the torque which resists or which drives the drive motor 27 is smoothed, said motor 27 thus being mainly subjected to the only resistant average torque necessary for maintaining the crankshaft 24 in regular rotation.

It will be noted that the inertia flywheel 66 can optionally be confined in a vacuum casing.

In this case, the power transmission to said flywheel 66 can be performed by contactless magnetic coupling.

It will also be noted that to facilitate the rotation of the crankshaft 24, the drive motor 27 can be rotatably fixedly secured to the inertia flywheel 66, while a disengageable coupler can be inserted between the assembly formed by said motor 27 and said flywheel 66 on the one hand, and the crankshaft 24 on the other hand, said coupler being able to be magnetic, hydraulic, or of any other type.

It has been shown in FIGS. 3 to 11 that the crankshaft 24 can comprise a ring gear 67 which the drive motor 27 drives in rotation by means of at least one ring drive pinion 68, the primitive diameter of which is smaller than that of said ring 67, the latter 67 and said pinion 68 forming a gearing mesh system 69.

As a variant of the slow-actuation mechanical liquid piston heat pump 1 according to the invention shown in FIGS. 5 to 11, an overflow pump 82 can transfer working liquid 13 from an overflow reservoir 83 to and directly or not, the compressor gas and liquid reservoir 14 and/or the compressor hydraulic variable volume 12 and/or the communication duct 15 which connects said reservoir 14 to said variable volume 12, said overflow reservoir 83 communicating with the compressor discharge plenum 62 so that the working gas pressure 5 which prevails in said reservoir 83 is close to or identical to that which prevails in said plenum 62.

Advantageously, the overflow pump 82 can transfer a little working liquid 13 at each reciprocating movement of longitudinal translation of the connecting rod 11.

Thus, when the double-acting hydraulic piston 10 performs reciprocating movements in the blind liquid cylinder 8 and when the compressor hydraulic variable volume 12 is minimum, the compressor gas and liquid reservoir 14 is fully filled with working liquid 13, the small quantity of working liquid 13 introduced by the overflow pump 82 in the gas and liquid reservoir 14 overflowing upon each rotation of the crankshaft 24 of said reservoir 14 to return to the overflow reservoir 83 via the outlet port 7 and the discharge plenum 62 of the compressor.

This particular configuration of the slow-actuation mechanical liquid piston heat pump 1 according to the invention enables all of the working gas 5 that the compressor pneumatic variable volume 2 contains to be expelled from said volume 2, when the compressor hydraulic variable volume 12 is minimum, which gives said volume 2 an infinite volume ratio, and a volume efficiency close to one hundred percent.

Similarly, and as shown in FIGS. 5 to 11, an overflow pump 82 can transfer working liquid 13 from an overflow reservoir 83 to and directly or not, the expander gas and liquid reservoir 137 and/or the expander hydraulic variable volume 134 and/or the communication duct 15 which connects said reservoir 137 to said variable volume 134, said overflow reservoir 83 communicating with the expander discharge plenum 143 so that the working gas pressure 5 which prevails in said reservoir 83 is close to or identical to that which prevails in said plenum 143.

Advantageously and similarly to the case of the compressor 3, the overflow pump 82 transfers a little working liquid 13 with each reciprocating movement of longitudinal translation of the connecting rod 11, and its effect is identical to that which it produces on the compressor 3.

Whether it is the compressor 3 or the expander 4, the overflow reservoir 83 is advantageously located below the compressor discharge plenum 62 or the expander discharge plenum 143 so that, due to the earth's gravity, the working liquid 13 which overflows from said reservoirs 14, 137 via the compressor discharge plenum 62 or the expander discharge plenum 143 naturally returns to the corresponding overflow reservoir 83.

Whether it applies to compressor 3 or expander 4, the overflow pump 82 comprises a pump blind cylinder 84 in which an overflow pump piston 85 can sealingly translate, the latter and said cylinder 84 forming a variable overflow pump volume 86 which, when it increases, is filled with working liquid 13 coming from the overflow reservoir 83 via at least one overflow pump intake flap 87 and which, when it decreases, discharges said liquid 13 successively via a discharge valve 88 and a discharge duct 157.

It is noted that the pump blind cylinder 84 can be assembled or not, i.e. that it can be made of one single part, or receive a cylinder head which closes its end opposite to that blocked by the overflow pump piston 85.

As shown in FIGS. 12 to 14, the overflow pump piston 85 can be a two-body staged piston 89 which comprises a large-diameter body 93 which has a large cross-section face 90 which forms one of the walls of the variable overflow pump volume 86, said staged piston 89 also comprising, axially opposite to the large cross-section face 90, a small-diameter body 94 which can sealingly translate into an actuation cylinder 92, the internal volume of which is connected directly or not to the discharge duct 157, said small-diameter body 94 having a small cross-section face 91 on which the pressure which prevails in the discharge duct 157 is exerted, said staged piston 89 also offering, at the junction between the large-diameter body 93 and the small-diameter body 94, an average cross-section face 95 from which the small-diameter body 94 emerges, which is connected to the overflow reservoir 83, and which is subjected to the pressure in said reservoir 83, while a staged piston abutment 117 fixes the maximum volume of the variable overflow pump volume 86 and a two-body piston return spring 96 tends to repel the two-body staged piston 89 towards its large cross-section face 90.

In this case, the discharge valve 88 can comprise a valve actuator piston 97 which can sealingly translate into a valve actuator cylinder 98 and which has, firstly, a valve actuation axial face 99 which communicates with the overflow reservoir 83 and on which the pressure in said cylinder 83 is exerted, said face 99 being able to raise an overflow flap 100 from an overflow flap seat 104, when the valve actuator piston 97 is moved towards said face 99 which has the effect of putting the variable overflow pump volume 86 in communication with the overflow duct 157 and secondly, a discharge duct side axial face 102 which communicates with the discharge duct 157, on which the pressure in said duct 157 is exerted, and which can come into contact with a discharge duct side abutment 118, when the valve actuator piston 97 is moved towards said discharge duct side axial face 102, while an actuation piston return spring 103 tends to repel the valve actuator piston 97 towards its valve actuation axial face 99, and an overflow flap return spring 128 tends to return the overflow flap 100 in contact with the overflow flap seat 104 with which it engages, the force that the actuation piston return spring 103 produces being greater than the force that the overflow flap return spring 128 produces.

As a non-represented alternative, the discharge valve 88 can comprise a cylindrical slide on the external surface of which a slide groove is provided, said slide being able to sealingly translate into a slide cylinder, into which an intake lumen opens, connected to the variable overflow pump volume 86, and an escape lumen which communicates with the discharge duct 157, while according to the axial position of the cylindrical slide in the slide cylinder, the slide groove can connect, or not, the intake lumen with the escape lumen, the cylindrical slide having a reservoir side axial face which communicates with the overflow reservoir 83 and on which the pressure prevailing in said reservoir 83 is exerted, and a discharge duct side axial face which can rest on a discharge duct side slide abutment, which communicates with the discharge duct 157 and on which the pressure prevailing in said duct 157 is exerted, while a slide return spring tends to repel the cylindrical slide towards its reservoir side axial face, up to a reservoir side slide abutment which, when it is reached by said slide, puts the intake lumen in communication with the escape lumen via the slide groove.

As shown in FIGS. 15 and 16, and in the particular context of the expander, the overflow pump piston 85 can be a two-body staged piston 89 which comprises a large-diameter body 93 which has a large cross-section face 90 which is connected to the overflow reservoir 83 and which is subjected to the pressure prevailing in said reservoir 83, said staged piston 89 also comprising, axially opposite to the large cross-section face 90, a small-diameter body 94 which can sealingly translate into an actuation cylinder 92, the internal volume of which is connected directly, or not, to the discharge duct 157, said small-diameter body 94 having a small cross-section face 91 on which the pressure prevailing in the discharge duct 157 is exerted, said staged piston 89 also offering, at the junction between the large-diameter body 93 and the small-diameter body 94, an average cross-section face 95 from which the small-diameter body 94 emerges, said face 95 forming one of the walls of the variable overflow pump volume 86, while a staged piston abutment 117 fixed the maximum volume of the variable overflow pump volume 86, and a two-body piston return spring 96 tends to repel the two-body staged piston 89 towards its small cross-section face 91.

In this latter case, the discharge valve 88 can comprise a valve actuator piston 97 which can sealingly translate into a valve actuator cylinder 98 and which has, firstly, a valve actuation axial face 99 which communicates with the discharge duct 157 and on which the pressure prevailing in said duct 157 is exerted, said face 99 being able to raise an overflow flap 100 from an overflow flap seat 104, when the valve actuator piston 97 is moved towards said face 99 which has the effect of putting the variable overflow pump volume 86 in communication with the discharge duct, and secondly, a reservoir side axial face 101 which communicates with the overflow reservoir 83, on which the pressure prevailing in said reservoir 83 is exerted, and which can come into contact with an overflow reservoir side abutment 130, when the valve actuator piston 97 is moved towards said reservoir side axial face 101, while an actuation piston return spring 103 tends to repel the valve actuator piston 97 towards its valve actuation axial face 99, and an overflow flap return spring 128 tends to return the overflow flap 100 in contact with the overflow flap seat 104 with which it cooperates, the force that the actuation piston return spring 103 produces being greater than the force that the overflow flap return spring 128 produces.

As a non-shown alternative, the discharge valve 88 can comprise a cylindrical slide on the external surface of which a slide groove is provided, said slide being able to translate into a slide cylinder, into which open an intake lumen connected to the variable overflow pump volume 86, and an escape lumen connected to the discharge duct 157, while according to the axial position of the cylindrical slide in the slide cylinder, the slide groove can connect or not the intake lumen with the escape lumen, the cylindrical slide having a reservoir side axial face, which can rest on a reservoir side slide abutment, which communicates with the overflow reservoir 83, and on which the pressure prevailing in said reservoir 83 is exerted, and a liquid cylinder side axial face which communicates with the discharge duct 157 and on which the pressure prevailing in said duct 157 is exerted, while a slide return spring tends to repel the cylindrical slide towards its liquid cylinder side axial face up to a liquid cylinder side slide abutment which, when it is reached by said slide, put the intake lumen in communication with the lumen space via the slide groove.

As shown in FIGS. 3 to 6 and 8, the double-acting hydraulic piston 10 may comprise at least two coaxial sealed discs 64, each of which has a low-pressure side axial piston face 65, which communicates with the low-pressure gas duct 61.

Alternatively, the double-acting hydraulic piston 10 may also comprise at least two coaxial sealed discs 64, each of which has a high-pressure side axial piston face (not shown), which communicates with the high-pressure gas duct 56.

### OPERATION OF THE INVENTION

The operation of the slow-actuation mechanical liquid piston heat pump 1 according to the invention is understood easily in view of FIGS. 1 to 16.

The aim of said heat pump 1 is, in particular, to constitute a compressor pneumatic variable volume 2 and an expander pneumatic variable volume 136 in which the heat exchanges are maximised between a working gas 5, which can be atmospheric air, and a working liquid 13, which can be water, during the compression or the expansion of said gas 5 and this, such that said compression or said expansion is as isothermal as possible, the working liquid 13 which has a high volume calorie capacity, mainly imposing its temperature on the working gas 5, the volume calorie capacity of which is lower.

The pressure-volume principle diagrams represented in FIG. 1 show the Carnot heat pump cycle executed by the slow-actuation mechanical liquid piston heat pump 1 according to the invention, and according to a particular embodiment of said pump 1, said cycle being operated partly by the compressor 3 with regard to the heat emission Q1, and partly by the expander 4 with regard to the heat absorption Q2.

As can be easily understood, the diagram at the top of FIG. 1 is executed by the compressor 3 which is also shown in FIGS. 3 to 11, while the diagram at the bottom of said FIG. 1 is executed by the expander 4 which is also shown in FIGS. 3 to 11, the two said diagrams being virtually connected in FIG. 1 by dotted arrows in order to reconstruct the complete thermodynamic cycle of the heat pump.

The dotted arrows illustrate that the hot working gas 5 at temperature T2 discharged by the compressor 3 under high-pressure via its compressor discharge plenum 62 is accepted by the expander 4 via its expander intake plenum 142, while the cold working gas 5 at temperature T1 discharged by the low-pressure expander 4 via its expander discharge plenum 143 is accepted by the compressor via its compressor intake plenum 21.

The heat pump cycle shown in FIG. 1 shows that the compressor 3 therefore accepts cold working gas 5 at temperature T1 during its intake stroke E-A.

Once this has been done, the compressor 3 performs an adiabatic compression A-B of the working gas 5 to bring the temperature of said gas 5 from cold T1 to hot T2.

Said adiabatic compression A-B is followed by isothermal compression B-C during which the work provided by the double-acting hydraulic piston 10 visible in FIGS. 3 to 6 and in FIGS. 8 and 11 is converted into heat Q1 which is exported to the heating means 18 via the heat export means 17, said means 18, 17 being clearly visible in FIGS. 3 to 6.

Then follows the discharge C-D of the compressed and hot working gas 5 at temperature T2 at the end of the compression stroke, followed by the intake E-A of cold working gas 5 at temperature T1 and at low-pressure from the expander 4, said intake forming the starting point of a new compression cycle.

The expander 4 for its part accepts compressed and hot working gas 5 at temperature T2 during its intake stroke F-G.

Once this has been done, the expander 4 carries out an adiabatic expansion G-H of the working gas 5 in order to cause the temperature thereof to pass from hot T2 to cold T1 and to render to the double-acting hydraulic piston 10 a part of the work consumed by said piston 10 during the adiabatic compression A-B carried out in the compressor 3.

Said adiabatic expansion G-H is followed by an isothermal expansion H-I during which the working gas 5 at cold temperature T1 still provides work to the double-acting hydraulic piston 10 visible in FIGS. 3 to 6 and in FIGS. 8 and 11, while maintaining the temperature of said gas 5 at value T1 by capturing heat Q2 which is imported from the cooling means 19 via the heat import means 138, said means 19, 138 being clearly visible in FIGS. 3 to 6.

The isothermal expansion stroke being completed, there follows the discharge I-J of the working gas 5 at low-pressure and cold at temperature T1, followed by the intake F-G of compressed and hot working gas 5 at temperature T2 from the compressor 3, which forms the starting point of a new expansion cycle.

FIG. 2 shows a variant of the thermodynamic heat pump cycle shown in FIG. 1 and which has just been described, said variant allowing a more relevant implementation of the slow-actuation mechanical liquid piston heat pump 1 according to the invention as shown in FIGS. 3 to 16.

In FIG. 2, the adiabatic compression of the working gas 5 carried out by the compressor 3 to pass from the cold temperature T1 to the hot temperature T2 is replaced by the input Q3 of heat to the working gas 5 accepted by the compressor 3 from the expander 4, said input coming from the regeneration heat exchanger 152 shown in FIGS. 3 to 6.

By means of said heat exchanger 152, the working gas 5 that circulates in the high-pressure gas duct 56 gives its heat to the working gas 5 that circulates in the low-pressure gas duct 61.

Thus, the working gas 5 admitted by the compressor 3 during its stroke D-A is already hot at temperature T2, while the working gas 5 admitted by the expander 4 during its stroke E-F is already cold at temperature T1.

As a result of this particular configuration of the slow-actuation mechanical liquid piston heat pump 1 according to the invention, the entire compression and discharge stroke of the working gas 5 from the compressor 3 can be operated isothermally, without prior heating of said gas 5 by adiabatic compression since said gas 5 is already at hot temperature T2.

The stroke A-B therefore forms from its start an isothermal compression during which the work provided by the double-acting hydraulic piston 10 is entirely converted into heat Q1 exported to the heating means 18 via the heat export means 17, said means 18, 17 being represented in FIGS. 3 to 6.

Then follows the discharge B-C of the compressed and hot working gas 5 at temperature T2 at the end of the compression stroke, followed by the intake D-A of working gas 5 also hot at temperature T2 and at low-pressure, from the expander 4, said intake forming the starting point of a new compression cycle.

Like what happens in the compressor 3, the principle of FIG. 2 also applies to the expander 4, that is to say that the entire expansion and discharge stroke of the working gas 5 of the expander 4 can be carried out isothermally, without prior cooling of said gas 5 by adiabatic expansion since said gas 5 is already at cold temperature T1 at the intake of said expander 4.

The stroke F-G therefore forms from its start an isothermal expansion during which part of the work provided by the double-acting hydraulic piston 10 during compression A-B is returned to it, by maintaining the temperature of the working gas 5 at value T1 by input heat Q2 from the cooling means 19 via the heat import means 138.

Then follows the discharge G-H of the cold working gas 5 at temperature T1 and low-pressure at the end of the expansion stroke, followed by the intake E-F of compressed and cold working gas 5 at temperature T1 from the compressor 3 via the regeneration heat exchanger 152, which forms the starting point of a new expansion cycle.

In addition to performing the thermodynamic cycles represented in FIGS. 1 and 2, the aim of the slow-actuation mechanical liquid piston heat pump 1 according to the invention is to meet the conditions necessary to obtain a significantly higher efficiency than that of conventional refrigerant gas heat pumps.

For this, the efficiency of the heat exchanges must be maximum, whether, for example, in the compressor gas and liquid reservoir 14 and in the expander gas and liquid reservoir 137 between the working gas 5 and the working liquid 13, in the regeneration heat exchanger 152 between the working gas 5 which circulates in the high-pressure gas duct 56 and that which circulates in the low-pressure gas duct 61, between the heat export means 17 and the heating means 18, or between the heat import means 138 and the cooling means 19.

It is to maximize the heat exchanges between the working gas 5 and the working liquid 13 that in FIGS. 5, 6, 8, and 11, it has been shown that the compressor heat exchange and accumulation means 16 can advantageously consist of a rotary liquid atomizer 158 which comprises a rotary atomization cylinder 159 pierced with radial atomization orifices 160, an atomizer motor 161 driving said cylinder 159 in rapid rotation so that the latter sucks in working liquid 13 at its axial end by centrifugation effect of said liquid 13, and by means of a pumping turbine 162.

Said rotary liquid atomizer 158 radially rejects working liquid 13 in the form of fine droplets into the internal volume of the compressor gas and liquid reservoir 14, via the radial atomization orifices 160, and fills the space with a mixture of working gas 5 and moving droplets of working liquid 13.

The efficiency of the exchanges depends in particular on the time devoted to them, which explains why the slow-actuation mechanical liquid piston heat pump 1 is actuated at low frequency, for example at a Hertz for a round trip of the double-acting hydraulic piston 10 in the blind liquid cylinder 8, which also leaves all the time necessary for the transfers to take place via the input port 6 and the output port 7 of the compressor 3 and the expander 4 in order to limit the losses by lamination of the working gas 5 as it passes through said ports 6, 7.

This low actuation frequency justifies the use of an inertia flywheel 66 rotating at high speed, for example at three thousand revolutions per minute, as shown in FIGS. 3 to 11, the instantaneous torque variations imposed on the crankshaft 24 by the compression or expansion of the working gas 5 in the compressor 3 and in the expander 4 being mainly absorbed by the inertia of said inertia flywheel 66, so that the torque that resists or drives the drive motor 27 is smoothed, said motor 27 then being mainly subjected to the resistant mean torque necessary to keep the crankshaft 24 in regular rotation.

Said efficiency of the exchanges also depends on the pressure and the density of the working gas 5, which is why we will take here as an example a slow-actuation mechanical liquid piston heat pump 1 according to the invention whose low-pressure found at the beginning of compression and at the end of expansion is fifty bars, and whose high-pressure found at the end of compression and at the beginning of expansion is one hundred and twenty bars.

The low compression ratio of two point four referred to here and the high operating pressures of the slow-actuation mechanical liquid piston heat pump 1 according to the invention, are favourable to a high compactness of said pump, and to a good regularity of heat power absorbed or emitted respectively by the expander 4 and by the compressor 3 during their expansion or compression stroke.

The efficiency of the slow-actuation mechanical liquid piston heat pump 1 according to the invention also depends on the volumetric ratio of its compressor 3 and its expander 4.

The higher said volumetric ratio, the higher the volumetric efficiency of said compressor 3 and said expander 4, which explains, among other things, the choice of a liquid piston formed by the working liquid 13 with the compressor gas and liquid reservoir 14 and with the expander gas and liquid reservoir 137.

To benefit from a volumetric ratio close to infinity, as shown in FIGS. 5 to 16, the compressor 3 and the expander 4 of the slow-actuation mechanical liquid piston heat pump 1 according to the invention each comprise an overflow pump 82 which guarantees that a minimum of residual working gas 15 does not remain in the gas and liquid reservoir 14, 137 at the end of the discharge stroke of said compressor 3 and said expander 4.

Achieving a breakthrough performance of the slow-actuation mechanical liquid piston heat pump 1 according to the invention compared to conventional refrigerant gas heat pumps also requires the minimization of mechanical friction.

As can be seen in FIGS. 4 to 6 and FIG. 8, regardless of the number of coaxial sealed disks 64 that it comprises, the double-acting hydraulic piston 10 always has a compressor side axial piston face 132 exposed to the pressure that prevails in the hydraulic variable volume of the compressor 12, and a expander side axial piston face 133 exposed to the pressure that prevails in the expander hydraulic variable volume 134.

This particular configuration ensures that a minimum force is not applied to the connecting rod actuating means 144 which in this case consist of a crankshaft 24 and an actuating rod 165.

In fact, the rod-crank system formed by said shaft 24 and said rod 165 is subject only to the difference between the force exerted on the connecting rod 11 by the compressor side axial piston face 132 and that exerted on said rod 11 by the expander side axial piston face 133.

To minimize the mechanical friction generated by the operation of the slow-actuation mechanical liquid piston heat pump 1 according to the invention and according to the configurations of said pump 1 shown in FIGS. 3 to 11, the double-acting hydraulic piston 10 is not subjected to any radial force despite the high axial forces to which it is subjected, resulting from a maximum pressure of for example one hundred and twenty bars according to this non-limiting example.

This is all the more necessary since the low speed of translation of the double-acting hydraulic piston 10 in the blind liquid cylinder 8 does not promote the establishment of a hydrodynamic lubricating regime at the contact interface between said piston 10 and said cylinder 8.

This is all the more necessary if the working liquid which interferes between the double-acting hydraulic piston 10 and the blind liquid cylinder 8 is water, the latter not being very viscous and having limited lubricating properties, which is also unfavourable to establishing a hydrodynamic bearing capacity system at the interface between said piston 10 and said cylinder 8.

In order to avoid subjecting the double-acting hydraulic piston 10 to any radial force, as can be seen in FIGS. 3 to 11, the connecting rod actuating means 144 by means of which the drive motor 27 imparts a longitudinal reciprocating translation movement to the connecting rod 11 advantageously consist of a crankshaft 24 which has a crank 26 about which the rod head 145 of an actuating rod 165 is articulated, the latter also comprising a rod foot 146 which is articulated about with the connecting rod 11 by means of a connecting crosshead 147.

As can be seen particularly in FIG. 11, the crosshead yoke 148 is traversed by a crosshead axis 155 which is perpendicular to the connecting rod 11 and about which are articulated, on the one hand, a rod foot bearing 149 that the rod foot 146 comprises by means of a roller bearing 105, and two crosshead rollers 150 with rollers which each roll alternately on two crosshead raceways 41 parallel to the blind liquid cylinder 8.

According to this particular configuration of the slow-actuation mechanical liquid piston heat pump 1 according to the invention, the radial forces which result from the obliqueness of the actuating rod 165 during the rotation of the crankshaft 24 are supported by the two crosshead rollers 150 with rollers positioned on either side of the crosshead yoke 148, which limits the friction losses which result from said radial forces.

It will also be noted in FIGS. 7 to 11 that the crankshaft 24 is also mounted on roller bearings 105, as well as the shaft that supports the inertia flywheel 66 and the shaft that supports, on the one hand, the rotor that is not visible in the figures of the drive motor 27, and, on the other hand, the ring drive pinion 68 secured to said rotor.

The actual friction coefficient of the roller bearings 105 being very low, they dissipate little energy and have little negative impact on the energy efficiency of the slow-actuation mechanical liquid piston heat pump 1 according to the invention.

It will also be noted that the gears comprised in the various rings and pinions which form a transmission multiplier 156 between the inertia flywheel 66 and the crankshaft 24 are advantageously precise and have a high transmission efficiency of more than ninety-nine percent.

It is also noted, for example in FIGS. 6 and 8, that the double-acting hydraulic piston 10 comprises two coaxial sealed discs 64 which each has a low-pressure side axial piston face 65 which communicates with the low-pressure gas duct 61.

This particular configuration greatly limits the friction of the seals 51 that the two said coaxial sealed discs 64 comprise, because during the entire low-pressure transfer stroke of the compressor 3 and the expander 4, said seals 51 are subjected to virtually no pressure differential, which minimizes the frictional energy losses produced by said seals 51, and maximizes the service life of the latter.

This limitation of the pressure differential applied to the seals 51 of said two coaxial sealed discs 64 also limits the leakage of working liquid 13 at said seals 51.

It is also noted that said two coaxial sealed discs 64 are axially sufficiently distant from each other to leave a portion of the blind liquid cylinder 8 non-swept by the double-acting hydraulic piston 10, which limits heat exchange by conduction through the blind liquid cylinder 8 between the compressor 3, which is hot, and the expander 4, which is cold.

To further limit said exchanges between the compressor 3 and the expander 4, the space between the two coaxial sealed discs 64 may be occupied by an air passivator or an insulating mass not shown.

It can be seen in FIG. 3 that advantageously, a partitioned heat-insulating enclosure 164 separates the compressor 3, the connecting rod actuating means 144, the drive motor 27 and the mechanical energy storage means 28, on the one hand, from the expander 4, said enclosure 164 also thermally separating said heat pump 1 from its external environment.

It will be understood that, according to this particular configuration of the slow-actuation mechanical liquid piston heat pump 1 according to the invention, almost all of the heat emitted as a result of the frictional or electromechanical energy losses generated by the compressor 3, the connecting rod actuating means 144, the drive motor 27 and the mechanical energy storage means 28 is reinjected into the heating means 18, which in this case consist of a heating-refreshing floor 106.

Particularly in FIGS. 3, 5, 6, 8 and 10, it is noted that the compressor discharge plenum 62 and the expander discharge plenum 143 are each connected to an overflow reservoir 83 the lower part of which comprises an overflow pump 82.

According to this particular configuration of the slow-actuation mechanical liquid piston heat pump 1 according to the invention, upon each rotation of the crankshaft 24, the overflow pumps 82 transfer, as the case may be, a small amount of working liquid 13 from their overflow reservoir 83 either to the compressor gas and liquid reservoir 14, or to the expander gas and liquid reservoir 137.

Said particular configuration makes it possible that when the double-acting hydraulic piston 10 performs reciprocating movements in the blind liquid cylinder 8 and when the compressor hydraulic variable volume 12 or the expander hydraulic variable volume 134 is minimum, the corresponding compressor gas and liquid reservoir 14 and the expander gas and liquid reservoir 137 is fully filled with working liquid 13, the small quantity of working liquid 13 introduced by the corresponding overflow pump 82 in the gas and liquid reservoir 14 overflowing upon each rotation of the crankshaft 24 of said reservoir 14, 137 to return to the overflow reservoir 83 via the corresponding outlet port 7.

This particular embodiment of the slow-actuation mechanical liquid piston heat pump 1 according to the invention makes it possible for all of the working gas 5 that the compressor pneumatic variable volume 2 contains, to actually be expelled from said volume 2, 136 when the compressor hydraulic variable volume 12 is minimum, which gives to said pneumatic variable volume 2, an infinite volume ratio, and a volume efficiency close to one hundred percent.

As can be easily derived from FIGS. 5 to 11, the pressure of the working gas 5 contained in the overflow reservoir 83 of the compressor 3 is similar to that which prevails in the compressor discharge plenum 62, while the pressure of the working gas 5 contained in the overflow reservoir 83 of the expander 4 is similar to that which prevails in the expander discharge plenum 143.

FIGS. 5 to 11 show that the overflow reservoirs 83 are located below the discharge plenum 62, 143 with which they cooperate so that, under the effect of earth's gravity, the working liquid 13 which overflows for example from the compressor gas and compressor liquid reservoir 14 via the compressor discharge plenum 62 naturally returns to the corresponding overflow reservoir 83, the configuration being identical in the case of the expander 3.

The overflow pump 82 has been shown in FIGS. 12 to 14, such that it can be provided for the compressor 3, according to a particular configuration of the slow-actuation mechanical liquid piston heat pump 1 according to the invention.

As is seen in said FIGS. 12 to 14, the overflow pump piston 85 is a two-body staged piston 89 which comprises a large-diameter body 93 which has a large cross-section face 90, the latter forming one of the walls of a variable overflow pump volume 86.

FIGS. 12 to 14 show that said staged piston 89 also comprises, axially opposite to the large cross-section face 90, a small-diameter body 94, which can sealingly translate into an actuation cylinder 92, the internal volume of which is connected directly or not to the discharge duct 157, said small-diameter body 94 having a small cross-section face 91, on which the pressure which prevails in said duct 157 is exerted, said pressure being referenced P2 in FIGS. 13 and 14.

It is also noted in FIGS. 12 to 14 that said staged piston 89 has, at the junction between the large-diameter body 93 and the small-diameter body 94, an average cross-section face 95 from which the small-diameter body 94 emerges, said face 95 being connected to the overflow reservoir 83 and being subjected to the pressure prevailing in said reservoir 83 referenced P1 in FIGS. 13 and 14, while a staged piston abutment 117 set the maximum volume of the variable overflow pump volume 86 and that a two-body piston return spring 96 tends to repel the two-body staged piston 89 towards its large cross-section face 90.

Thus, and as is easily understood from FIG. 13, when the pressure P2 which prevails in the discharge duct 157 is less than the pressure P1, which prevails in the overflow reservoir 83, the two-body staged piston 89 is maintained pressed on the staged piston abutment 117 while the two-body piston return spring 96 is compressed by the force that the pressure difference P1 minus P2 produces, exerted over the entire surface of the small cross-section face 91, the discharge valve 88 being closed.

When the pressure P2 which prevails in the compressor pneumatic variable volume 2 and therefore in the discharge duct 157 becomes substantially equal to the pressure P1 which prevails in the overflow reservoir 83, there is no longer a force which is exerted on the small cross-section face 91, and the two-body piston return spring 96 repels the two-body staged piston 89 as FIG. 14 shows, which has the effect of expelling the working liquid 13 from the variable overflow pump volume 86 to the discharge duct 157 via the open discharge valve 88, the actual energy consumption of the transferring of said liquid 13 from said volume 86 to said duct 157 being very low.

When the pressure of the working gas 5 in the compressor gas and liquid reservoir 14 drops abruptly, which corresponds to the section C-D of the pressure-volume diagram of FIG. 2, the discharge valve 88 is calculated to close immediately while the pressure P2 prevailing in the discharge duct 157 becomes again lower than the pressure P1 prevailing in the overflow reservoir 83.

Following the compression of the two-body piston return spring 96 by the two-body staged piston 89, the latter being moved under the effect of the pressure difference P1 minus P2 which is exerted on the small cross-section face 91 with, at the same time, the increasing of the variable overflow pump volume 86, into which a new working liquid 13 load coming from the overflow reservoir 83 is taken in, and via the overflow pump intake flap 87.

As is noted in FIGS. 13 and 14, the discharge valve 88 comprises a valve actuator piston 97 which can sealingly translate into a valve actuator cylinder 98.

Said piston 97 has a valve actuation axial face 99 which communicates with the overflow reservoir 83 and on which the pressure P1 prevailing in said reservoir 83 is exerted.

As is seen in FIG. 14, said axial face 99 can come into contact with an overflow flap 100 to raise the latter from an overflow flap seat 104 when the valve actuator piston 97 moves towards said face 99.

In this case, and considering the particular position of the overflow pump 82 shown in FIGS. 7 and 10, the variable overflow pump volume 86 is put into communication with the discharge duct 157 via said overflow flap 100.

It is also noted in FIGS. 13 and 14 that the valve actuator piston 97 also has a discharge duct side axial face 102 which communicates with the discharge duct 157 and on which the pressure P2 prevailing in said duct 157 is exerted, said face 102 being able to come into contact, as shown in FIG. 12, with a liquid cylinder side abutment 118 when the valve actuator piston 97 moves towards said discharge duct side axial face 102.

In FIGS. 13 and 14, it is noted that an actuation piston return spring 103 tends to repel the valve actuator piston 97 towards its valve actuation axial face 99, and that an overflow flap return spring 128 tends to return the overflow flap 100 in contact with the overflow flap seat 104 with which it cooperates.

As is easily derived from FIGS. 13 and 14, such that the discharge valve 88 can operate, the force that the actuation piston return spring 103 produces must be greater than the force that the overflow flap return spring 128 produces.

Thus, and as is easily understood from FIGS. 13 and 14, when the pressure P2 which prevails in the discharge duct 157 is less than the pressure P1 which prevails in the overflow reservoir 83, the discharge duct side axial face 102 of the valve actuator piston 97 is maintained pressed on the liquid cylinder side abutment 118, while the actuation piston return spring 103 is compressed by the force that the pressure difference P1 minus P2 produces between that which is exerted on the valve actuation axial face 99 and that which is exerted on the discharge duct side axial face 102.

In this case, the overflow flap 100 rests on its overflow flap seat 104, and the working liquid 13 cannot circulate between the variable overflow pump volume 86 and the discharge duct 157.

When the pressure P2 which prevails in the compressor pneumatic variable volume 2 and therefore in the discharge duct 157 becomes substantially equal to the pressure P1 which prevails in the overflow reservoir 83, the pressure which is exerted on the valve actuation axial face 99 is equivalent to that which is exerted on the discharge duct side axial face 102.

It results from this situation, that the actuation piston return spring 103 repels the valve actuator piston 97 towards the overflow flap 100, until the valve actuation axial face 99 comes into contact with said flap 100, then raises the latter from its overflow flap seat 104 and this, until said flap 100 reaches a maximum flap opening abutment 131.

The overflow flap 100 being moved away from its overflow flap seat 104, the two-body staged piston 89 can be moved under the action of its two-body piston return spring 96, and expel working liquid 13 from the variable overflow pump volume 86 to the discharge duct 157.

When the pressure of the working gas 5 in the compressor gas and liquid reservoir 14 drops abruptly, which corresponds to section C-D of the pressure-volume diagram of FIG. 2, the pressure P2 prevailing in the discharge duct 157 becomes lower than the pressure P1 prevailing in the overflow reservoir 83.

The compression of the actuation piston return spring 103 by the valve actuator piston 97 results from this, the latter being moved under the effect of the pressure difference P1 minus P2 between that which is exerted on its valve actuation axial face 99, and that which is exerted on its discharge duct side axial face 102, said piston 97 leaving the overflow flap return spring 128 returning the overflow flap 100 in contact with its overflow flap seat 104.

It is noted in FIGS. 15 and 16, that the overflow pump 82 of the expander 4 falls under the same principles as those which have just been described, with this difference that the transferring of working liquid 13 from the overflow reservoir 83 to the discharge conduit 157 occurs not when the pressure which prevails in the expander pneumatic variable volume 136 is high, around one hundred and twenty bars according to this example, but on the contrary when said pressure is low, around fifty bars still according to this example.

This is due to the fact that the cycle of the compressor 3 occurs, on average, at a pressure lower than that prevailing in the compressor discharge plenum 62 of said compressor 3, while the cycle of the expander 4 occurs, on average, at a pressure greater than that in the expander discharge plenum 143.

Therefore, such that the filling of the variable overflow pump volume 86 can occur, the operation with respect to the pressure differences of the overflow pump 82 of the compressor 3 must be inverted with respect to that of the overflow pump 82 of the expander 4.

As can be easily derived from FIG. 6, the power of the slow-actuation mechanical liquid piston heat pump 1 according to the invention can be set either by varying the rotational speed of the crankshaft 24, or by varying the compression ratio of the compressor 3 and the expansion ratio of the expander 4.

This last mode of setting the power of said pump 1 operates by adapting the lift laws of the controlled expander valves 54, the latter each being actuated in opening and/or closing by a valve actuator 119.

Said control of the rotational speed of the crankshaft 24, the compression ratio of the compressor 3, and the expansion ratio of the expander 4, are provided by a computer 120.

Indeed, with all things being equal, the power of the slow-actuation mechanical liquid piston heat pump 1 according to the invention is proportional to the rotational speed of its crankshaft 24, which is a first setting which allows the computer 120 to set said power.

But, further to the rotation speed of its crankshaft 24, the more or less late and more or less staggered raising of the controlled expander valves 54 makes it possible, in particular, to set the pressure which prevails in the low-pressure gas reservoir 60 shown in FIGS. 3 to 6 relative to that which prevails in the high-pressure gas reservoir 58, also shown in FIGS. 3 to 6.

This setting has a great importance, in that the pressure difference in question determines, in particular, the quantity of heat produced by the heat pump 1 upon each rotation of the crankshaft 24.

This setting occurs, for example, by making the expander 4 transfers less working gas 5 from the high-pressure gas reservoir 58 to the expander gas and liquid reservoir 137 during the section E-F of the diagram of said expander 4 of FIG. 2, than the compressor 3 transfers during the section B-C of said diagram, which has the effect of making the pressure increase in the high-pressure gas reservoir 58, while making the pressure lower in the low-pressure gas reservoir 60.

On the contrary, if the expander 4 transfers more working gas 5 from the high-pressure gas reservoir 58 to the compressor gas and liquid reservoir 14 during the cross-section E-F of the diagram of said expander 4 of FIG. 2, than the compressor 3 transfers during the cross-section B-C of said diagram, the pressure in the high-pressure gas reservoir 58 lowers, while the pressure increases in the low-pressure gas reservoir 60.

It will be noted that advantageously, the controlled expander valves 54 can behave both like valves and like flaps, i.e. that it can open under the effect of a pressure difference, in addition to being actuated in opening by their valve actuator 119.

In this regard, said valves 54 are preferably autoclaves, i.e. that during the majority of the time of the thermodynamic cycle of the expander 4, the pressure difference between the expander intake plenum 142 and the expander gas and liquid reservoir 137, or that between the expander discharge plenum 143 and said reservoir 137, tends to maintain said valves 54 pressed on their seat, the latter being able to be, for example, constituted of an elastomer or polymer O-ring housed in a groove.

However, if the pressure in the expander gas and liquid reservoir 137 becomes greater than that in the expander intake plenum 142, the controlled expander valve 54 can open without intervention of its valve actuator 119.

The same applies for the controlled expander valve 54, which communicates with the expander discharge plenum 143 via its outlet port 7, said valve 54 being able to open without intervention of its valve actuator 119, if the pressure which prevails in said plenum 143 becomes greater than that which prevails in the expander gas and liquid reservoir 137.

From FIGS. 3 to 6, it can easily be derived that the slow-actuation mechanical liquid piston heat pump 1 according to the invention can operate in “heating” mode when the heating-cooling floor 106 placed inside a building 121 forms the heating means 18 which are connected to the heat export means 17, while the air-water exchanger 107 placed outside 122 of said building 121 constitutes the cooling means 19 which are connected to the heat import means 138.

If the heat pump 1 operates in “air-conditioning” mode, the heating and cooling floor 106 placed inside said building 121 forms the cooling means 19 which are connected to the heat import means 138, while the air-water exchanger 107 placed outside 122 of said building 121 constitutes the cooling means 18 which are connected to the heat export means 17.

The change of mode can easily be performed by inverting the heat transport conduits 38 using one or more manual or motorised valves, whatever their type, said ducts 38 initially connected to the compressor 3 becoming connected to the expander 4, and vice versa.

It will be noted that the slow-actuation mechanical liquid piston heat pump 1 according to the invention can, in addition to the various members and accessories shown in FIGS. 3 to 16, comprise various other apparatuses and accessories such as pressure and/or temperature sensors, a frequency converter to regulate the electrical power supply of the electrical drive motor 27 sequentially according to the angle of the crankshaft 24 or continuously, at least one angular encoder and/or or a passage detection sensor which returns to the computer 120 the speed and/or the angular position of the crankshaft 24, one or more pumps and/or compressors and/or valves making it possible to transfer working gas 5 or working liquid 13 from external sources to the high-pressure gas reservoir 58 or the low-pressure gas reservoir 60 or between said reservoirs 58, 60 in particular to balance the glycol level in the water between that contained in the compressor 3 and that contained in the expander 4, purges, safety elements for people, pressure limiters or relief valves, or any other apparatus known to those skilled in the art.

For example, FIG. 6 shows a condensate reservoir 42 that collects the condensates at the outlet of the high-pressure gas duct 56, after the working gas 5 leaving the compressor 3 at high temperature has been cooled in the regeneration heat exchanger 152.

Said condensate reservoir 42 cooperates with a condensate return valve 31 controlled by the computer 120 to cyclically return the working liquid condensates 13 into the compressor gas and liquid reservoir 14 using the pressure differences.

The slow-actuation mechanical liquid piston heat pump 1 according to the invention can also comprise a thermal insulation layer on all the necessary members, and whatever the nature of said layer which can take the form of foam or flexible or rigid insulating wool, insulating bricks, plates or screens which reflect radiation of any kind.

The thermal insulation layer can insulate the heat pump 55 and its components from the outer environment and/or insulate the compressor 3 which is hot, from the expander 4 which is colder.

Said heat pump 1 can also receive an acoustic insulation envelope, and its static frame 40 can rest on the floor by way of anti-vibration elastic studs.

It will also be noted that collectors of suspended droplets of iron or stainless steel wool may be provided in the compressor discharge plenum 62 and/or in the expander discharge plenum 143.

It is understood that many architectures are applicable to the slow-actuation mechanical liquid piston heat pump 1 according to the invention, with a vertical blind liquid cylinder 8, a compressor gas and liquid reservoir 14 and/or an expander gas and liquid reservoir 137 offset and connected to the blind liquid cylinder 8 by a communication duct 15 of any geometry and any length.

It should also be noted that several blind liquid cylinders 8 can cooperate, the double-acting hydraulic pistons 10 of which are set in motion by connecting rod actuating means 144 that are common or not, phased or angularly offset, synchronized or not, said cylinders 8 being able to be juxtaposed, superposed, mounted head to tail, in opposition or according to any relative position and orientation whatsoever.

The options of the slow-actuation mechanical liquid piston heat pump 1 according to the invention are not limited to the applications which have just been described, and it must moreover be understood that the description above has only been given as an example and that it does not at all limit the scope of said invention, which is not moved away from by replacing the details of execution described by any other equivalent.

1-36. (canceled)

37. A slow-actuation mechanical liquid piston heat pump (1) comprising a compressor (3) in which a compressor pneumatic variable volume (2) is formed, and an expander (4) in which a expander pneumatic variable volume (136) is formed, each said volume (2, 136) comprising, on the one hand, an inlet port (6) through which a working gas (5) can enter and, on the other hand, an outlet port (7) through which said gas (5) can exit, characterised in that it comprises:
At least one blind liquid cylinder (8) which is formed by one or more coaxial cylindrical sections (63), which is directly or indirectly secured to a static frame (40), at least two ends of which are each closed off by a sealed cylinder termination (135), and in which at least one double-acting hydraulic piston (10) comprising one or more coaxial sealed discs (64) can be translated in a sealed manner, said piston (10) having, on the one hand, at least one compressor side axial piston face (132) which forms, with said cylinder (8) and a sealed cylinder termination (135), a compressor hydraulic variable volume (12), and, on the other hand, at least one expander side axial piston face (133) which forms, with said cylinder (8) and another sealed cylinder termination (135), a expander hydraulic variable volume (134), the two said hydraulic variable volumes (12, 133) being completely or partially filled with a working liquid (13);
A compressor gas and liquid reservoir (14) which is connected to the compressor hydraulic variable volume (12) by a communication duct (15), such that said reservoir (14) is mainly or totally filled with working liquid (13) when the compressor hydraulic variable volume (12) is minimum, said reservoir (14) being totally or partially filled with working gas (5) when the compressor hydraulic variable volume (12) is maximum, the variation of volume of the working gas (5) contained in the compressor gas and liquid reservoir (14) defining on the one hand, the compressor pneumatic variable volume (2), and being on the other hand, approximately equal to the variation of volume of the working liquid (13) contained in the compressor hydraulic variable volume (12);
An expander gas and liquid reservoir (137) which is connected to the expander hydraulic variable volume (134) by a communication duct (15), such that said reservoir (137) is mainly or totally filled with working liquid (13) when the expander hydraulic variable volume (134) is minimum, and is totally or partially filled with working gas (5) when the expander hydraulic variable volume (134) is maximum, the variation of volume of the working gas (5) contained in the expander gas and liquid reservoir (137) defining on the one hand, the expander pneumatic variable volume (2), and being on the other hand, approximately equal to the variation of volume of the working liquid (13) contained in the expander hydraulic variable volume (134);
Compressor heat exchange and accumulation means (16) which are housed in the compressor gas and liquid reservoir (14), said means (16) being able mainly to take heat from the working gas (5) contained in said reservoir (14) and temporarily store said heat, before giving the latter to the working liquid (13) also contained in said reservoir (14);
Expander heat exchange and accumulation means (139) which are housed in the expander gas and liquid reservoir (137), said means (139) being able mainly to take heat from the working liquid (13) contained in said reservoir (137) and temporarily store said heat, before giving the latter to the working gas (5) also contained in said reservoir (137);
Heat export means (17) housed inside and/or outside the compressor gas and liquid reservoir (14), said means (17) directly or indirectly taking heat from the compressor heat exchange and accumulation means (16), on the one hand, and/or from the working liquid (13) and/or from the working gas (5) that said reservoir (14) contains in whole or in part, on the other hand, said heat then being transferred to heating means (18) external to the compressor gas and liquid reservoir (14);
Heat import means (138) housed inside and/or outside the expander gas and liquid reservoir (137), said means (138) directly or indirectly supplying heat to the expander heat exchange and accumulation means (139), on the one hand, and/or to the working liquid (13) and/or to the working gas (5) that said reservoir (137) contains in whole or in part, on the other hand, said heat having been previously taken from cooling means (19) external to the expander gas and liquid reservoir (137);
Compressor filling means (20) which enable or prohibit the passage of working gas (5) from a compressor intake plenum (21) to the compressor gas and liquid reservoir (14) via the inlet port (6) of the compressor (3);
Compressor draining means (22) which enable or prohibit the passage of working gas (5) from the compressor gas and liquid reservoir (14) to a compressor discharge plenum (62) via the outlet port (7) of the compressor (3);
Expander filling means (140) which enable or prohibit the passage of working gas (5) from an expander intake plenum (142) to the expander gas and liquid reservoir (137) via the inlet port (6) of the expander (4);
Expander draining means (141) which enable or prohibit the passage of working gas (5) from the expander gas and liquid reservoir (137) to an expander discharge plenum (143) via the outlet port (7) of the expander (4);
A connecting rod (11) that is secured to the double-acting hydraulic piston (10), that sealingly passes through at least one of the ends of the blind liquid cylinder (8), and that is approximately parallel to the longitudinal axis of said piston (10) and of the blind liquid cylinder (8);
Piston guiding means (23) which maintain the hydraulic piston (10) and the connecting rod (11) parallel to said blind liquid cylinder (8), whatever the position of said piston (10) in said cylinder (8);
Connecting rod actuating means (144) by means of which a drive motor (27) imparts to the connecting rod (11) a reciprocating longitudinal translational movement parallel to the axis of the blind liquid cylinder (8);
Mechanical energy storage means (28) which are directly or indirectly connected to the connecting rod actuating means (144) and/or to the connecting rod (11) itself, said storage means (28) being able to alternately take and give mechanical energy to said actuating means (144) and/or to said connecting rod (11).

38. mechanical liquid piston heat pump according to claim 37, characterised in that the connecting rod actuating means (144) consist of a crankshaft (24) which is oriented perpendicularly to the blind liquid cylinder (8), and which can rotate in at least one shaft bearing (25) which is directly or indirectly secured to the static frame (40), said crankshaft (24) having at least one crank (26) around which a rod head (145) of an actuating rod (165) is articulated, the latter also having a rod foot (146) which is articulated with the connecting rod (11), the latter passing in a sealed manner through at least one of the sealed cylinder terminations (135).

39. The mechanical liquid piston heat pump according to claim 38, characterised in that the rod foot (146) is articulated with the connecting rod (11) by means of a connecting crosshead (147) which is secured to said rod (11).

40. The mechanical liquid piston heat pump according to claim 39, characterised in that the connecting crosshead (147) comprises a crosshead yoke (148) which is traversed by a crosshead axis (155) which is perpendicular to the connecting rod (11) and about which are articulated, on the one hand, a rod foot bearing (149) which the rod foot (146) comprises, and at least one crosshead roller (150) which rolls on at least one crosshead raceway (41) which is parallel to the blind liquid cylinder (8), and which is directly or indirectly secured to said cylinder (8).

41. The mechanical liquid piston heat pump according to claim 37, characterised in that the double-acting hydraulic piston (10) consists of two coaxial sealed discs (64) which are axially sufficiently distant from each other to leave a portion of the blind liquid cylinder (8) not swept by said piston (10).

42. The mechanical liquid piston heat pump according to claim 37, characterised in that the compressor heat exchange and accumulation means (16) are constituted of a porous medium (32) which has porosities (33) into which and from which the working liquid (13) and the working gas (5) alternatively enter and exit.

43. The mechanical liquid piston heat pump according to claim 37, characterised in that the heat export means (17) are constituted of a circulating part of the working liquid (13), said part exiting from the compressor hydraulic variable volume (12) or from the compressor gas and liquid reservoir (14) via a liquid outlet duct (34) to then return into said volume (12) or into said reservoir (14) via a liquid inlet duct (35), this after having given heat to the heating means (18).

44. The mechanical liquid piston heat pump according to claim 43, characterised in that the circulating part of the working liquid (13) gives heat to the heating means (18) via a heating secondary heat exchanger (153).

45. The mechanical liquid piston heat pump according to claim 37, characterised in that the heat import means (138) are constituted of a circulating part of the working liquid (13), which leaves the expander hydraulic variable volume (134) and/or the expander gas and liquid reservoir (137) via a liquid outlet duct (34) and then returns to said volume (134) and/or to said reservoir (137) via a liquid inlet duct (35), this after having directly or indirectly taken heat from the cooling means (19).

46. The mechanical liquid piston heat pump according to claim 45, characterised in that the circulating part of the working liquid (13) takes heat from the cooling means (19) by means of a cooling secondary heat exchanger (154).

47. The mechanical liquid piston heat pump according to claim 37, characterised in that the heat export means (17) are constituted of at least one heat exchanger duct (36) housed in the compressor gas and liquid reservoir (14) and in which a heat-transfer fluid (37) circulates, which exports heat taken from the compressor heat exchange and accumulation means (16) and/or from the working liquid (13) and/or from the working gas (5) contained in the compressor gas and liquid reservoir (14), and on the other hand, to the heating means (18) via heat transport ducts (38).

48. The mechanical liquid piston heat pump according to claim 38, characterised in that the heat import means (138) are constituted of at least one heat exchanger duct (36) housed in the expander gas and liquid reservoir (137) and in which a heat-transfer fluid (37) circulates, which imports heat from the cooling means (19) to the expander heat exchange and accumulation means (139) and/or to the working liquid (13) and/or to the working gas (5) contained in the compressor gas and liquid reservoir (14), on the other hand, via heat transport ducts (38).

49. The mechanical liquid piston heat pump according to claim 37, characterised in that the compressor heat exchange and accumulation means (16) are constituted of at least one liquid spray nozzle (71) supplied by a liquid spray pump (72), said nozzle (71) being able to atomise the working liquid (13) into fine droplets in the internal volume of the compressor gas and liquid reservoir (14).

50. The mechanical liquid piston heat pump according to claim 37, characterised in that the expander heat exchange and accumulation means (139) are constituted of at least one liquid spray nozzle (71) supplied by a liquid spray pump (72), said nozzle (71) being able to atomise the working liquid (13) into fine droplets in the internal volume of the expander gas and liquid reservoir (137).

51. The mechanical liquid piston heat pump according to claim 37, characterised in that the compressor heat exchange and accumulation means (16) consist of a rotary liquid atomiser (158) which comprises a rotary atomising cylinder (159) pierced with radial atomising orifices (160), an atomiser motor (161) driving said cylinder (159) in rapid rotation so that the latter sucks in working liquid (13) at its axial end by centrifugation effect and/or by means of a pumping turbine (162), and radially rejects said liquid (13) in the form of fine droplets into the internal volume of the compressor gas and liquid reservoir (14), via the radial atomising orifices (160).

52. The mechanical liquid piston heat pump according to claim 37, characterised in that the expander heat exchange and accumulation means (139) consist of a rotary liquid atomiser (158) which comprises a rotary atomising cylinder (159) pierced with radial atomising orifices (160), an atomiser motor (161) driving said cylinder (159) in rapid rotation so that the latter sucks in working liquid (13) at its axial end by centrifugation effect and/or by means of a pumping turbine (162), and radially rejects said liquid (13) in the form of fine droplets into the internal volume of the expander gas and liquid reservoir (137), via the radial atomising orifices (160).

53. The mechanical liquid piston heat pump according to claim 37, characterised in that the piston guiding means (23) are constituted of a sliding pivot connection (47) formed between an external cylindrical surface (48) that the connecting rod (11) has, and a guiding orifice (49) which is securely connected to the blind liquid cylinder (8).

54. The mechanical liquid piston heat pump according to claim 37, characterised in that the piston guiding means (23) are constituted of a guiding skirt (57) arranged at the periphery of the hydraulic piston (10), said skirt (57) being able to translate at a low clearance into said blind liquid cylinder (8).

55. The mechanical liquid piston heat pump according to claim 37, characterised in that the compressor filling means (20) and/or the compressor draining means (22) are constituted of at least one compressor flap (52) and/or at least one controlled compressor valve (53), while in operation, the working gas (5) is expelled from the compressor gas and liquid reservoir (14) via the compressor discharge plenum (62) under a pressure greater than that under which it has been introduced beforehand in said reservoir (14) via the compressor intake plenum (21).

56. The mechanical liquid piston heat pump according to claim 37, characterised in that the expander filling means (140) and/or the expander draining means (141) are constituted of at least one controlled expander valve (54), while in operation, the working gas (5) is expelled from the expander gas and liquid reservoir (137) via the expander discharge plenum (143) under a pressure less than that under which it has been introduced beforehand in said reservoir (137) via the expander intake plenum (142).

57. The mechanical liquid piston heat pump according to claim 37, characterised in that the compressor discharge plenum (62) is connected to the expander intake plenum (142) by a high-pressure gas duct (56) so that the working gas (5) exiting from the compressor pneumatic variable volume (2) via said compressor discharge plenum (62) is introduced into the expander pneumatic variable volume (136) via said expander intake plenum (142), while the expander discharge plenum (143) is connected to the compressor intake plenum (21) by a low-pressure gas duct (61) so that the working gas (5) exiting from the expander pneumatic variable volume (136) via said expander discharge plenum (143) is introduced into the compressor pneumatic variable volume (2) via said compressor intake plenum (21).

58. The mechanical liquid piston heat pump according to claim 57, characterised in that the high-pressure gas duct (56) is connected to at least one high-pressure gas reservoir (58).

59. The mechanical liquid piston heat pump according to claim 57, characterised in that the high-pressure gas duct (61) is connected to at least one high-pressure gas reservoir (60).

60. The mechanical liquid piston heat pump according to claim 57, characterised in that the working gas (5) which circulates in the high-pressure gas duct (56) gives its heat to the working gas (5) which circulates in the low-pressure gas duct (61) by means of a regeneration heat exchanger (152).

61. The mechanical liquid piston heat pump according to claim 37, characterised in that the compressor intake plenum (21) and the compressor discharge plenum (62) are positioned in the upper part of the compressor gas and liquid reservoir (14), the latter itself being positioned above the blind liquid cylinder (8), such that due to the Earth's gravity, the working gas (5) always exits firstly from the reservoir (14) via the discharge plenum (62), and that the working liquid (13) always enters firstly in said reservoir (14) via the intake plenum (21).

62. The mechanical liquid piston heat pump according to claim 37, characterised in that the expander intake plenum (142) and the expander discharge plenum (143) are positioned in the upper part of the expander gas and liquid reservoir (137), the latter itself being positioned above the blind liquid cylinder (8), such that due to the Earth's gravity, the working gas (5) always exits firstly from the reservoir (137) via the discharge plenum (143), and that the working liquid (13) always enters firstly in said reservoir (137) via the intake plenum (142).

63. The mechanical liquid piston heat pump according to claim 38, characterised in that the mechanical energy storage means (28) consist of an inertia flywheel (66) made secured in rotation to the crankshaft (24) by a transmission multiplier (156).

64. The mechanical liquid piston heat pump according to claim 38, characterised in that the crankshaft (24) comprises a ring gear (67) which the drive motor (27) drives in rotation by means of at least one ring drive pinion (68), the primitive diameter of which is smaller than that of said ring (67), the latter (67) and said pinion (68) forming a gearing mesh system (69).

65. The mechanical liquid piston heat pump according to claim 37, characterised in that an overflow pump (82) can transfer working liquid (13) from an overflow reservoir (83) to and directly or not, the compressor gas and liquid reservoir (14) and/or the compressor hydraulic variable volume (12) and/or the communication duct (15) which connects said reservoir (14) to said variable volume (12), said overflow reservoir (83) communicating with the compressor discharge plenum (62) such that the working gas pressure (5) which prevails in said reservoir (83) is close to or identical to that which prevails in said plenum (62).

66. The mechanical liquid piston heat pump according to claim 37, characterised in that an overflow pump (82) can transfer working liquid (13) from an overflow reservoir (83) to and directly or not, the expander gas and liquid reservoir (137) and/or the expander hydraulic variable volume (134) and/or the communication duct (15) which connects said reservoir (137) to said variable volume (134), said overflow reservoir (83) communicating with the expander discharge plenum (143) such that the working gas pressure (5) which prevails in said reservoir (83) is close to or identical to that which prevails in said plenum (143).

67. The mechanical liquid piston heat pump according to claim 65, characterised in that the overflow pump (82) comprises a blind pump cylinder (84) into which an overflow pump piston (85) can sealingly translate, the latter and said cylinder (84) forming a variable overflow pump volume (86) which, when it increases, is filled with working liquid (13) coming from the overflow reservoir (83) via at least one overflow pump intake flap (87) and which, when it decreases, discharges said liquid (13) successively via a discharge valve (88) and a discharge duct (157).

68. The mechanical liquid piston heat pump according to claim 65, characterised in that the overflow pump piston (85) is a two-body staged piston (89) which comprises a large-diameter body (93) which has a large cross-section face (90) which forms one of the walls of the variable overflow pump volume (86), said staged piston (89) also comprising, axially opposite to the large cross-section face (90), a small-diameter body (94) which can sealingly translate into an actuation cylinder (92), the internal volume of which is connected, directly or not, to that of the discharge duct (157), said small-diameter body (94) having a small cross-section face (91) on which the pressure which prevails in the liquid cylinder (157) is exerted, said staged piston (89) also offering, at the junction between the large-diameter body (93) and the small-diameter body (94), an average cross-section face (95) from which the small-diameter body (94) emerges, which is connected to the overflow reservoir (83), and which is subjected to the pressure prevailing in said reservoir (83), while a staged piston abutment (117) fixes the maximum volume of the variable overflow pump volume (86) and that a two-body piston return spring (96) tends to repel the two-body staged piston (89) towards its large cross-section face (90).

69. The mechanical liquid piston heat pump according to claim 68, characterised in that the discharge valve (88) comprises a valve actuator piston (97) which can sealingly translate into a valve actuator cylinder (98) and which has, on the one hand, a valve actuation axial face (99) which communicates with the overflow reservoir (83) and on which the pressure prevailing in said reservoir (83) is exerted, said face (99) being able to raise an overflow flap (100) from an overflow flap seat (104) when the valve actuator piston (97) moves towards said face (99) which has the effect of putting the variable overflow pump volume (86) in communication with the discharge duct (157), and on the other hand, a discharge duct side axial face (102) which communicates with the discharge duct (157), on which the pressure prevailing in said duct (157) is exerted, and which can come into contact with a discharge duct side abutment (118) when the valve actuator piston (97) moves towards said discharge duct side axial face (102), while an actuation piston return spring (103) tends to repel the valve actuator piston (97) towards its valve actuation axial face (99), and that an overflow flap return spring (128) tends to return the overflow flap (100) in contact with the overflow flap seat (104) with which it cooperates, the force that the actuation piston return spring (103) produces being greater than the force that the overflow flap return spring (128) produces.

70. The mechanical liquid piston heat pump according to claim 66, characterised in that the overflow pump piston (85) is a two-body staged piston (89) which comprises a large-diameter body (93) which has a large cross-section face (90) which is connected to the overflow reservoir (83) and which is subjected to the pressure prevailing in said reservoir (83), said staged piston (89) also comprising, axially opposite to the large cross-section face (90), a small-diameter body (94), which can sealingly translate into an actuation cylinder (92), the internal volume of which is connected, directly or not, to the discharge duct (157), said small-diameter body (94) having a small cross-section face (91) on which the pressure which prevails in the discharge duct (157) is exerted, said staged piston (89) also offering, at the junction between the large-diameter body (93) and the small-diameter body (94), an average cross-section face (95) from which the small-diameter body (94) emerges, said face (95) forming one of the walls of the variable overflow pump volume (86), while a staged piston abutment (117) set the maximum volume of the variable overflow pump volume (86) and that a two-body piston return spring (96) tends to repel the two-body staged piston (89) towards its small cross-section face (91).

71. The mechanical liquid piston heat pump according to claim 70, characterised in that the discharge valve (88) comprises a valve actuator piston (97) which can sealingly translate into a valve actuator cylinder (98) and which has, on the one hand, a valve actuation axial face (99) which communicates with the discharge duct (157) and on which the pressure prevailing in said duct (157) is exerted, said face (99) being able to raise an overflow flap (100) from an overflow flap seat (104) when the valve actuator piston (97) moves towards said face (99) which has the effect of putting the variable overflow pump volume (86) in communication with the discharge duct (157), and secondly, a reservoir side axial face (101) which communicates with the overflow reservoir (83), on which the pressure prevailing in said reservoir (83) is exerted, and which can come into contact with an overflow reservoir side abutment (130) when the valve actuator piston (97) is moved towards said reservoir side axial face (101), while an actuation piston return spring (103) tends to repel the valve actuator piston (97) towards its valve actuation axial face (99), and that an overflow flap return spring (128) tends to return the overflow flap (100) in contact with the overflow flap seat (104) with which it engages, the force that the actuation piston return spring (103) produces being greater than the force that the overflow flap return spring (128) produces.

72. The mechanical liquid piston heat pump according to claim 57, characterised in that the double-acting hydraulic piston (10) comprises at least two coaxial sealed discs (64) which each have a low-pressure side piston axial face (65) which communicates with the low-pressure gas duct (61).
